(19) United States
(12) Patent Application Publication
(10) Pub. No.: US 2006/0051476 A1
(43) Pub. Date: Mar. 9, 2006

(54) Tubular hopper with synchronized tray and method

(76) Inventor: Joan Fabre Fornaguera, Sant Cugat del Valles (ES)

Correspondence Address: Bell, Boyd & Lloyd LLC, P.O. Box 1135, Chicago, IL, 60690-1135, US

(21) Appl. No.: 11/175,074

(22) Filed: Jul. 5, 2005

Related U.S. Application Data
(63) Continuation-in-part of application No. 11/071,373, filed on Mar. 2, 2005.
Application No. 11/071,373 is a continuation-in-part of application No. 10/933,954, filed on Sep. 3, 2004.

(51) Int. Cl. A23L 1/00

(52) U.S. Cl. 426/516

(57) ABSTRACT

The present invention provides an apparatus for producing a confectionery article that includes a rotary valve in fluid communication with a fluid confectionery source and a dispensing outlet. A conveyor moves a tray under the dispensing outlet. Rotation of the rotary valve to a dispensing position dispenses an amount of fluid confectionery from the dispensing outlet and into the tray. Rotation of the rotary valve and movement of the tray may be coordinated to provide an orderly and smooth confectionery depositing process.

This application is a continuation-in-part of U.S. patent application Ser. No. 11/071,373 filed on Mar. 2, 2005 which is a continuation-in-part of U.S. patent application Ser. No. 10/933,954 filed on Sep. 3, 2004.

### BACKGROUND

Multiple layer confectioneries enjoy widespread appeal. Confectionery consumers are attracted to candies having multiple layers, flavors and colors arranged in various creative designs and shapes. Systems for producing such multiple component confectionery articles typically utilize a depositing apparatus that injection deposits two or more fluid confectionery streams into a mold to form the confectionery article. Formation of multiple layer candies requires an ability to control production parameters such as confectionery intake amount and confectionery injection rate, for example.

Conventional depositing apparatuses used in the production of multiple layer candies, however, have several drawbacks. Customary gravity-feed arrangements for the fluid confectionery yield substantial inconsistency in the amount of confectionery drawn into the depositing apparatus. The confectionery deposit amount consequently varies significantly between deposit cycles. In addition, spring loaded depositing valves used in current depositing apparatuses are prone to sealing problems resulting in valve leakage and tailing. These and other shortcomings in the art lead to undesirable levels of product reject as uniformity in layer thickness cannot be controlled with a satisfactory degree of accuracy.

A need therefore exists for a confectionery depositing apparatus capable of producing multiple layered confectionery articles with a high degree of accuracy and control. A need further exists for a precision confectionery depositing apparatus capable of forming thin layers of confectionery product and thin coating layers in particular.

### SUMMARY

The present invention provides a confectionery depositing apparatus and method that deposits one or more confectionery streams with an improved degree of control and accuracy. The present invention thereby provides an apparatus capable of depositing precise amounts of flowable confectionery product in layer form. The depositing apparatus of the present invention is particularly suited to form very thin uniform layers of confectionery product.

In an embodiment, the confectionery depositing apparatus includes a source of a flowable confectionery, a cylinder, and a rotary valve in fluid communication with the source of flowable confectionery, and the cylinder. Placement of the rotary valve in a first position permits the flowable confectionery into the cylinder and placement of the rotary valve in a second position permits dispensing of the flowable confectionery from the cylinder out of the apparatus. The rotary valve includes a channel that establishes fluid communication between the source and the cylinder when the rotary valve is in the first position and fluid communication between the cylinder and an outlet when the rotary valve is in the second position.

In an embodiment, the apparatus also includes a piston in cooperative or otherwise operational engagement with the cylinder. Movement of the piston in a first or upward direction transfers the flowable confectionery into the cylinder when the rotary valve is in the first position, and movement of the piston in a second or downward direction dispenses the flowable confectionery from the cylinder when the rotary valve is in the second position. In a further embodiment, a very small gap or no gap whatsoever is present between an exterior circumferential surface of the piston head and an interior circumferential surface of the cylinder. In the event a gap is present, the gap may have a length of from about 0 mm to 0.05 mm. This tight operative engagement between the piston and cylinder interior advantageously provides the apparatus of the present invention to accurately transfer an amount of confectionery from the source into the cylinder and subsequently deposit this amount from the apparatus. In an embodiment, the piston head remains in the cylinder during the movement of the piston. This advantageously provides the present invention with a substantially airtight confectionery intake arrangement.

In a further embodiment, the apparatus deposits successive amounts of confectionery articles. The weight variance between these successive amounts may be between from about 0.01% to about 1.0%.

In a further embodiment of the present invention, a confectionery depositing apparatus for producing a laminated confectionery article is provided. The apparatus includes a first source of a first flowable confectionary and a second source of a second flowable confectionary, a first cylinder and a second cylinder corresponding to the first and second sources respectively and a rotary valve in fluid communication with the first and second sources and the first and second cylinders. Placement of the rotary valve in a first position permits the transfer of the first confectionery and the second confectionery to the first and second cylinders respectively and placement of the rotary valve in a second position permits dispensing of the first confectionery and the second confectionery from the first and second cylinders respectively.

In an embodiment, the apparatus also includes a nozzle in fluid communication with the rotary valve. The nozzle may deposit the first and second confectionery into a mold having a diameter substantially equal in length with the diameter of the nozzle. This arrangement prevents the first and second confectionery streams from adversely commingling with each other. Alternatively, the length of the nozzle diameter and the mold diameter may be different to mix the confectionery streams as desired.

In an embodiment, the apparatus may also include a first piston and a second piston in cooperative operation with the first and second cylinders respectively. Movement of the first and second pistons in a first or upward direction transfers the first and second confectionery to the respective first and second cylinder when the rotary valve is in the first position. Movement of the pistons in a second or downward direction dispenses the first and second confectionery from the respective first and second cylinders into the nozzle when the rotary valve is in the second position. Consequently, the nozzle may be used to coextrude the first confectionery with the second confectionery when the rotary valve is in the second position. The coextruded first confectionery stream may encase the second confectionery stream.

In an embodiment, the first piston may be moved at a rate different than the rate of movement for the second piston. Alternatively, the piston head diameter, the stroke distance, and/or the confectionery density may be varied to coextrude different amounts of first and second confectioneries.

A method of producing a confectionery product is provided in yet a further embodiment of the present invention. The method includes providing a depositing apparatus having a rotary valve in fluid communication with a source of a flowable confectionary, a cylinder, and an outlet. An amount of the flowable confectionery may be transferred into the cylinder when the rotary valve is in a first position. The method includes dispensing the confectionery amount from the cylinder through the outlet when the rotary valve is in a second position. The method also entails moving the rotary valve between the first and second positions.

In an embodiment, the method includes moving a piston that is in operative engagement with the cylinder in a first or upward direction in order to transfer the amount of confectionery from the source into the cylinder. The piston may then be subsequently moved in a second or downward direction to discharge the amount from the cylinder when the rotary valve is move to the second position.

In an embodiment, the method includes determining the quantity of the first amount by moving the piston a first predetermined distance in the first direction and moving the piston the predetermined distance in the second direction to discharge the amount from the cylinder. The first predetermined distance and the second predetermined distance may be substantially equal. The method may further include dispensing successive amounts of confectionery product from the apparatus. The amounts may have a weight variance from about 0.01% to about 1.0%.

A method of producing a laminated confectionery product is provided in another embodiment of the present invention. The method includes providing a confectionery depositing apparatus having a rotary valve in fluid communication with a first source of a flowable confectionary and a corresponding first cylinder, a second source of a flowable confectionary and a corresponding second cylinder, and a nozzle. A first amount of the first confectionery and a second amount of the second confectionery are then transferred into the first and second cylinder respectively when the rotary valve is in a first position. The method includes coextruding the first and second amount from the nozzle when the rotary valve is in a second position to form a multilayered confectionary article. The quantity of the first and second amounts may be the same or different. The extrusion rate of the first and second amounts may be the same or different.

In an embodiment, the method may include discharging the first and second amounts from the respective first and second cylinders into the nozzle when the rotary valve is in the second position to encase the second amount with the first amount. The method may thereby include forming a coated confectionery article.

A further embodiment of the present invention provides a confectionery article. The confectionery article includes a core coextruded to a coating, the coating present in an amount from about 5% to about 30% by weight of the confectionery article. In an embodiment, the coating is substantially continuous and encases or otherwise surrounds the entire core. The composition of the coating and core may be the same or different. In an embodiment, the coating is a composition different than the core. In a further embodiment, coating is present from about 5% to about 10% by weight. In yet a further embodiment, the coating may have a thickness from about 0.05 mm to about 2.0 mm.

In yet another embodiment of the present invention, an apparatus for producing a confectionery article is provided that includes a passageway for accommodating a flow of fluid confectionery. A rotary valve surrounds the passageway and is rotatable about the passageway for dispensing the fluid confectionery from the passageway. In an embodiment, the apparatus further includes a piston and cylinder assembly that may be placed into fluid communication with the passageway when the rotary valve is moved or otherwise rotated to a first position. A piston upstroke may subsequently transfer an amount of fluid confectionery into the cylinder of the piston and cylinder assembly. Rotation of the rotary valve to a second position places the piston and cylinder assembly in fluid communication with a dispensing nozzle. A piston downstroke may then deliver the fluid confectionery present in the cylinder to the dispensing nozzle thereby dispensing the fluid confectionery from the apparatus. In an embodiment, the flow of fluid confectionery is delivered from a fluid confectionery source to the passageway. Any fluid confectionery remaining in the passageway upon completion of the depositing cycle is delivered to the fluid confectionery source through a closed system. The present invention advantageously eliminates evaporation of the fluid confectionery and volatile components therein such as flavors and fragrances during the depositing process. The present invention further promotes production economy as unused fluid confectionery may be reused in subsequent depositing cycles.

In a further embodiment, the apparatus for producing a confectionery article includes a first and a second passageway for accommodating respective first and second flows of fluid confectionery. First and second rotary valves surround the respective first and second passageways for dispensing the first and second fluid confectioneries from the passageways and into a dispensing nozzle. The dispensing nozzle dispenses the first and the second fluid confectioneries from the apparatus. In an embodiment, the dispensing nozzle is a coextrusion nozzle for forming a laminated confectionery article. In an embodiment, the apparatus may include a first and a second piston and cylinder assembly in operative communication with each respective passageway and rotary valve. A piston upstroke when each valve is in a first position may transfer an amount of the first and second fluid confectionery to a respective first and second cylinder. A piston downstroke when the rotary valve is in a second position may deliver the first and second fluid confectionery present in each respective cylinder to the coextrusion nozzle thereby enabling the apparatus to produce a laminated confectionery article.

In a further embodiment, a method for producing a confectionery product is provided. The method includes providing an apparatus having a passageway for accommodating a flow of fluid confectionery and a rotary valve surrounding the passageway for dispensing the fluid confectionery from the passageway and dispensing with the valve an amount of the fluid confectionery from the passageway. In an embodiment, the method includes providing a passageway for accommodating a first flow of fluid confectionery in fluid communication with a first rotary valve circumferentially surrounding the first passageway, and providing a second passageway for accommodating a second flow of fluid confectionery in fluid communication with a second rotary valve circumferentially surrounding the second passageway. The method includes delivering with the first and second valves a respective first amount of the first fluid confectionery and a second amount of the second fluid confectionery to a dispensing nozzle and coextruding the first amount and the second amount from the nozzle.

In a further embodiment, an apparatus for producing a confectionery article includes a rotary valve in fluid communication with a fluid confectionery source, a dispensing outlet, and a conveyor for moving a tray under the outlet. The rotary valve is rotatable to a fluid confectionery dispensing position. The dispensing outlet is in fluid communication with the rotary valve. In an embodiment, a controller is placed in operative communication with the rotary valve and the conveyor to coordinate the rotation of the rotary valve and the movement of the tray to a fluid confectionery receiving position. An amount of fluid confectionery may then be dispensed from the dispensing outlet and into the tray.

In an embodiment, the apparatus includes a piston and cylinder assembly in fluid communication with the rotary valve. A piston upstroke when the rotary valve is rotated to an intake position transfers an amount of fluid confectionery from the fluid confectionery source and into the cylinder. A piston downstroke when the rotary valve is in the dispensing position dispenses the transferred amount of fluid confectionery through the rotary valve, through the dispensing outlet and into the tray. The piston and cylinder assembly may be placed in operative communication with the controller. The piston upstroke and/or downstroke may be coordinated with rotation of the rotary valve and/or movement of the tray to the fluid confectionery receiving position.

In an embodiment, the apparatus may include a base upon which the apparatus is supported. The base is moveable to a depositing position, the depositing position placing the dispensing outlet in cooperative relation with the fluid confectionery receiving position for the tray. The moveable base may be placed in operative communication with the controller so that the controller may coordinate any combination of rotary valve rotation, piston upstroke/downstroke, tray movement to the fluid confectionery receiving position and movement of the base to the depositing position. The base may also be moved to an idle position.

In an embodiment, the apparatus may include a first and a second rotary valve in fluid communication with respective first and second fluid confectionery sources, the first and second rotary valves in fluid communication with the dispensing outlet. Each rotary valve may also be in fluid communication with a respective piston and cylinder assembly. The apparatus may be supported by the moveable base. The controller may be used to coordinate first and second valve rotation, piston upstroke/downstroke, movement of the tray to the confectionery receiving position and movement of the base to the depositing position. In this embodiment, the apparatus may dispense first and second amounts of respective first and second fluid confectioneries to form a laminated confectionery article.

In a further embodiment, a method for depositing a fluid confectionery is provided. The method includes providing an apparatus having a rotary valve in fluid communication with a fluid confectionery source and a dispensing outlet, rotating the rotary valve to a fluid confectionery dispensing position, moving a tray under the dispensing outlet and coordinating the rotary valve rotation with the tray movement. The tray may be moved or otherwise placed to a fluid confectionery receiving position under the dispensing outlet. The apparatus may also include a piston and cylinder assembly in fluid communication with the rotary valve to transfer an amount of fluid confectionery from the source into the cylinder and subsequently dispense this amount from the cylinder, through the rotary valve and out of the dispensing outlet. In an embodiment, the method may include coordinating rotary valve rotation with placement of the tray in the confectionery receiving position and the stroke (up and/or down) of the piston. The apparatus may also be moveable to a depositing position whereby the method may include coordinating any combination of rotary valve rotation, tray movement, piston stroke and movement of the apparatus to the depositing position.

In a further embodiment, the method includes providing an apparatus having a first rotary valve in fluid communication with a first fluid confectionery source, a second rotary valve in fluid communication with a second confectionery source, and a dispensing outlet. The method entails rotating the first and second rotary valves to respective first and second fluid confectionery dispensing positions, moving a tray under the dispensing outlet and coordinating the rotation of the first and second rotary valves with the tray movement. The apparatus may include piston and cylinder assemblies in operative communication with each rotary valve for transferring and dispensing a first amount of the first fluid confectionery and a second amount of the second fluid confectionery from the dispensing outlet. The apparatus may also include a moveable base that brings the apparatus to a depositing position. The method may include coordinating the rotation of the first and second rotary valves, the piston strokes (up and/or down), placement of the tray to the fluid confectionery receiving position, and bringing the base and/or apparatus to the depositing position. In an embodiment, the method may include dispensing a first amount of the first fluid confectionery and a second amount of the second fluid confectionery in the tray and forming a laminated confectionery article. The method may include coextruding the first amount with the second amount. The method may further include encasing one dispensed amount with the other dispensed amount and forming an encased confectionery article.

Additional features and advantages of the present invention are described in, and will be apparent from, the following Detailed Description and the Figures.

### BRIEF DESCRIPTION OF THE FIGURES

FIG. 1 is a perspective view of a confectionery depositing apparatus in accordance with the present disclosure.

FIG. 2 is a perspective view of the apparatus of FIG. 1 illustrating the inner components of the apparatus.

FIG. 3 is a sectional view of the confectionery depositing apparatus taken along line 3-3 of FIG. 2.

FIG. 4 is a sectional view of the apparatus taken along line 4-4 of FIG. 2.

FIG. 5 is a perspective view of a manifold in accordance with the present disclosure.

FIG. 6 is a front elevational of the manifold of FIG. 5.

FIG. 7 is a perspective view of a rotary valve in accordance with the present disclosure.

FIG. 8 is a schematic representation of the confectionery deposing apparatus when the rotary valve is in a first position.

FIG. 9 is a schematic representation of the confectionery depositing apparatus when the rotary valve is in a first position.

FIG. 10 is a schematic representation of the confectionery depositing apparatus when the rotary valve is in a second position.

FIG. 11 is a schematic representation of the confectionery depositing apparatus when the rotary valve is in a second position.

FIG. 12 is a sectional view of a confectionery article produced in accordance with the present disclosure.

FIG. 13 is a perspective view of a further embodiment of the confectionery depositing device in accordance with the present disclosure.

FIG. 14 is an exploded break-away view of the confectionery depositing device of FIG. 13.

FIG. 15 is a schematic representation of the confectionery depositing device of FIG. 13 when the rotary valve is in a first position.

FIG. 16 is a schematic representation of the confectionery depositing device of FIG. 13 when the rotary valve is in a second position.

FIG. 17 is a perspective view of a further embodiment of a confectionery depositing apparatus.

FIG. 18 is a fragmentary perspective view of the confectionery depositing apparatus of FIG. 17 in an idle position.

FIG. 19 is a fragmentary perspective view of the confectionery depositing apparatus of FIG. 17 in a depositing position.

FIG. 20 is a side elevational view of the confectionary depositing apparatus of FIG. 17 in the depositing position.

FIG. 21 is a side elevational view of the confectionery depositing apparatus of FIG. 17 in the idle position.

### DETAILED DESCRIPTION

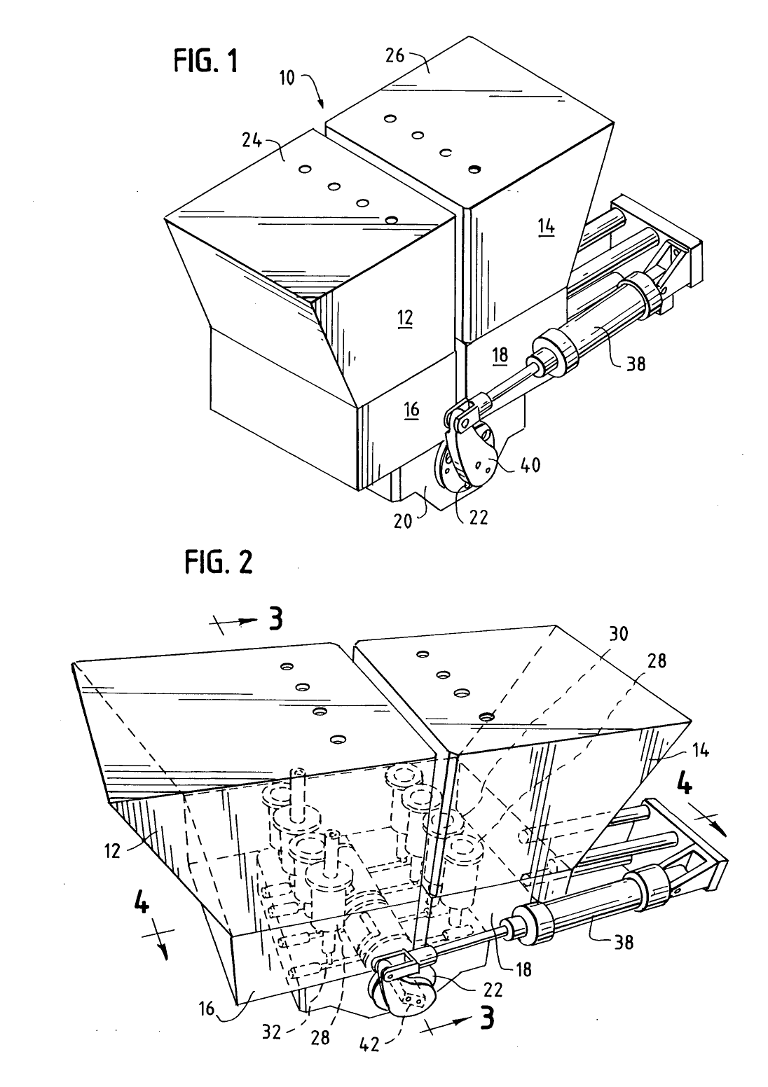

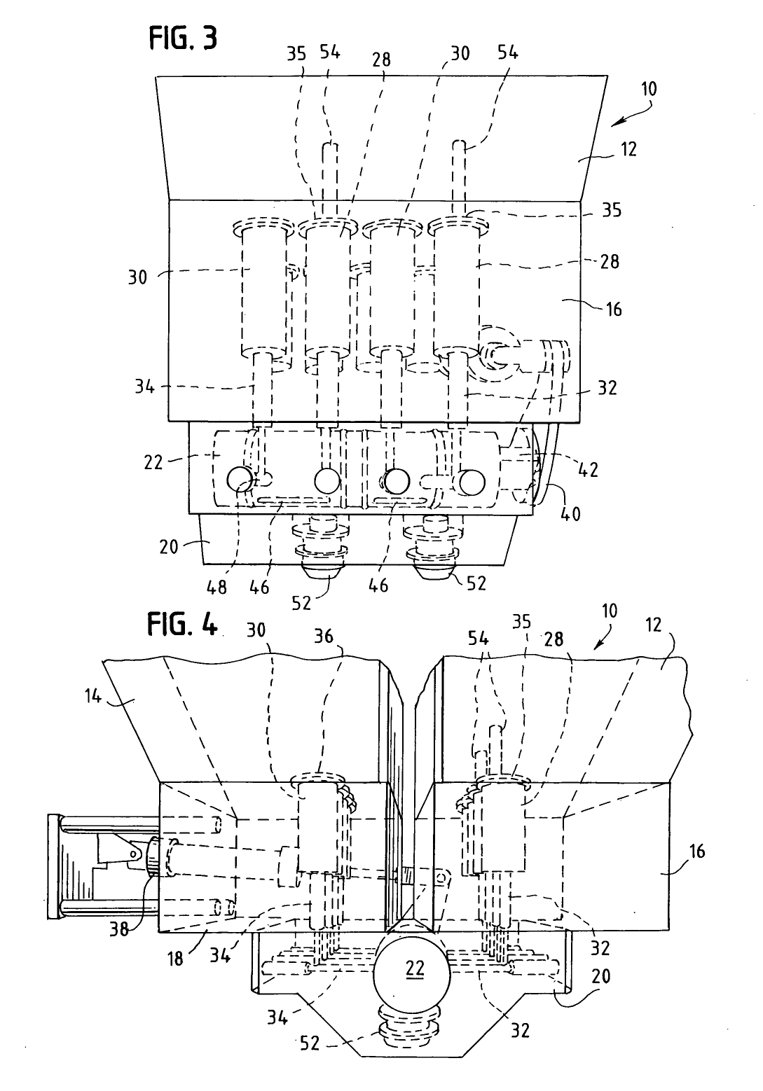

Referring to the Figures generally, where like reference numerals denote like structure and elements, and in particular to FIGS. 1-4, a confectionery depositing apparatus 10 for producing a confectionery product is shown in accordance with an embodiment of the present invention. Apparatus 10 includes confectionery sources 12 and 14, housings 16 and 18, and a manifold 20 having a rotary valve 22. Apparatus 10 is typically a component of a larger continuous confectionery production system that deposits a stream or streams of fluid or flowable confectionery into a plurality of individual molds moved into a depositing position by a continuous transporter such as a conveyor, for example. The system may also include a packaging stage as is commonly known in the art.

Confectionery sources 12 and 14 may be any container or reservoir suitably adapted to contain or otherwise hold a quantity of flowable confectionery product as is commonly known in the art, such as a hopper, for example. The confectionery product may be any confectionery substance, material, or compound that is a fluid or may take a flowable form. The confectionery product of the present invention may be a syrup or a liquid, for example. In addition, the confectionery product may be melted, or dissolved at a temperature above ambient to become flowable as is commonly known in the art. The skilled artisan will appreciate that the moisture content (and concomitant viscosity) of the confectionery product may vary greatly. The moisture content of the flowable confectionery is typically in the range of about 2% to about 12% by weight of the confectionery product. The flowable confectionery product may then be deposited into a mold or a shape-defining receptacle wherein the confectionery product subsequently solidifies at room temperature to form a solid confectionery article such as a hard candy, a soft candy, a chewing gum or combinations thereof. Nonlimiting examples of suitable confectionery products that are flowable or may placed into a flowable state include syrups, liquids or solids for making hard candies, soft candies, lollipops, fondants, toffees, jellies, chewing gums, chocolates, gelatins and nougats. The confectionery product of the present invention may include sugar or may be sugar-free. Coloring may be added to each confectionery product as desired. The confectionery product may also be substituted by a pharmaceutical product or a medicament that may prepared into a flowable state in a similar manner.

Apparatus 10 may include as few as a single confectionery source to as many as three, four, or five or more confectionery sources. Each confectionery source may include heating elements (not shown) to maintain the confectionery product in a flowable state. The sources may be adapted to maintain each confectionery product at the same or at different temperatures. Covers 24 and 26 may be removably attached to sources 12 and 14 respectively permitting addition of the confectionery product into each respective source. Covers 24 and 26 may then be used enclose the inner areas of each confectionery source in order to protect the confectionery product from contaminants. The confectionery product contained in sources 12 and 14 may the same or different. In an embodiment, each confectionery source contains a different confectionary product.

Sources 12 and 14 are in fluid communication with housings 16 and 18 as shown in FIGS. 2-4. Housings 16 and 18 include cylinders 28 and inlets 30. Each cylinder 28 is associated with a respective inlet 30 and may be put in fluid communication with the associated inlet as will be described in detail below. The cylinders and inlets are generally annular in shape. In an embodiment, cylinder 28 has an interior circumferential surface or wall that is substantially uniform (i.e., the inner cylinder wall has no openings thereon) defining an inner area or volume that is capable of holding a quantity of flowable confectionery product. The inlets and cylinders extend from the top surface of the housings into the interior of the housings. Bores 32 extend from a bottom opening of each cylinder through the housings and into manifold 20 providing fluid communication between each cylinder and rotary valve 22. Similarly, ducts 34 extend from a bottom opening of each inlet and extend through the housings and into manifold 20 placing each inlet in fluid communication with rotary valve 22.

The top of each cylinder includes a cylinder opening 35 and the top of each inlet includes an inlet opening 36. Inlet opening 36 is exposed to a lower area of the confectionery source thereby placing inlet opening 36 in fluid communication with the flowable confectionery product contained in sources 12 and 14. This configuration permits the flowable confectionery product to readily enter the inlets 30 and flow through a respective duct 34 to rotary valve 22. Each cylinder 28 is associated with or mated with a respective inlet 30. Each housing 16 or 18 may include from one cylinder/inlet pair to as many as five, 10, 20, or 30 or more cylinder/inlet pairs. It is understood that description of a single cylinder and/or inlet applies equally to each cylinder and/or inlet.

Although FIGS. 1-4 show confectionery sources 12 and 14 proximate to and abutting respective housings 16 and 18, it will be appreciated that the confectionery sources may be remote from each respective housing. In this embodiment, the confectionery source may be a reservoir or other receptacle suitable for holding the flowable confectionery product at a location remote from the housing. Piping may be used to fluidly connect the confectionery source with each inlet, for example.

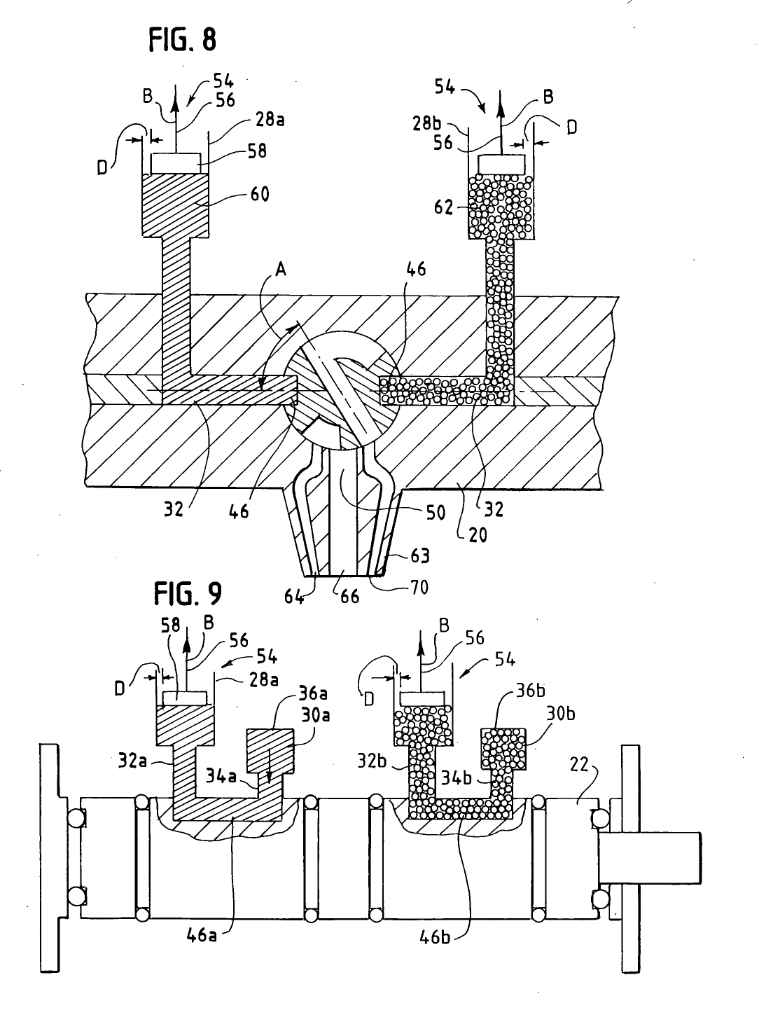

Referring to FIG. 1, a driving arm 38 powered by a power source (not shown) drives or otherwise propels a camber 40 which is connected to a support member 42 of rotary valve 22 to transfer the translational force imparted by arm 38 into a rotational force that actuates or otherwise rotates rotary valve 22. Extension and retraction of driving arm 38 thereby turns rotary valve 22 between a first position and a second position. The amount of extension and retraction of arm 38 may be adjusted as desired so that the rotational arc distance between the first position and the second position may be from about 5° to about 180°. In an embodiment, the arc distance between the first position and the second position is about 45°, as shown by arc segment A in FIG. 8.

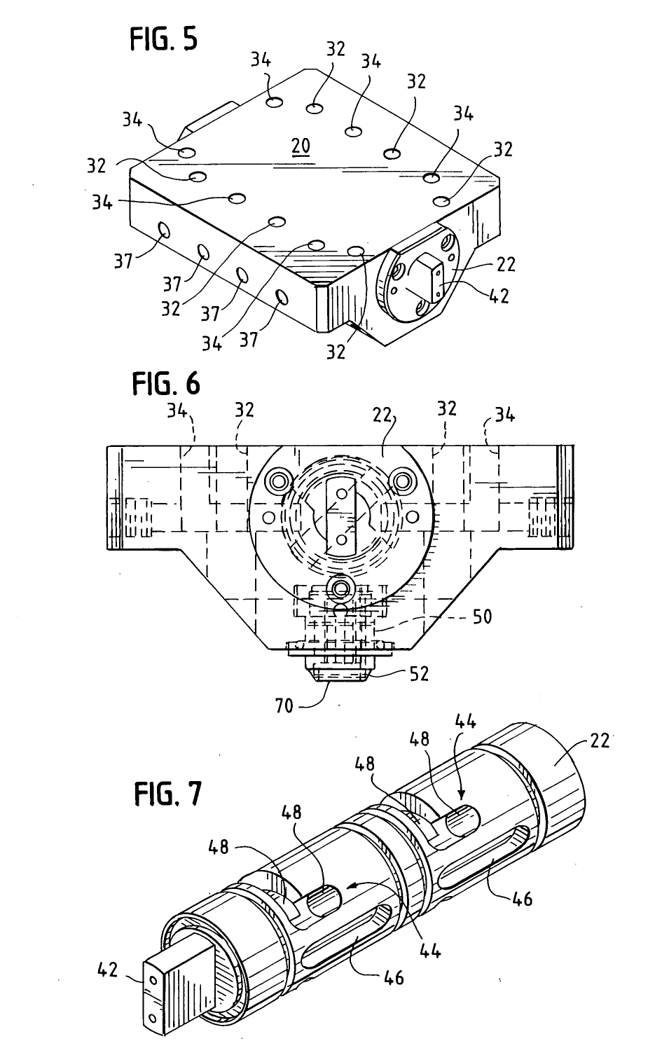

FIGS. 5-7 illustrate manifold 20 which houses rotary valve 22. Manifold 20 is adapted to permit rotary valve 22 to rotate or otherwise turn between a first transfer position and a second dispensing or depositing position. Bores 32 and ducts 34 from housings 16 and 18 extend into manifold 20 fluidly connecting the cylinders and inlets respectively to rotary valve 22. In an embodiment, manifold 20 may include ports 37 which are in fluid communication with bores 32, ducts 34, and rotary valve 22 in order to allow for cleaning or unclogging of the same.

In an embodiment, rotary valve 22 includes a channel 44 having a transfer passage 46 and a dispensing passage 48 as shown in FIG. 7. Transfer passage 46 fluidly connects bore 32 and duct 34 when the rotary valve is in the first position. This provides fluid communication between cylinder 28 and the corresponding inlet 30 associated with cylinder 28. Placement of rotary valve 22 in the first position thereby permits the flowable confectionery product to flow into the inner volume of cylinder 28. In particular, when rotary valve 22 is in the first position, the flowable confectionery flows from either source 12 or 14 into inlet 30 through duct 34, through transfer passage 46 into bore 32 and into the inner area of cylinder 28.

When the rotary valve is rotated or moved to the second position, dispensing passage 48 moves into fluid communication with cylinder 28 permitting the amount of flowable confectionary product present in cylinder 28 to be dispensed therefrom. In particular, when rotary valve 22 is in the second position, the flowable confectionery present within cylinder 28 flows into dispensing passage 48 and flows out from the bottom of manifold 20 through a manifold outlet 50 as shown in FIG. 6. In an embodiment, a nozzle 52 may be affixed to the underside of manifold 20 to be in fluid communication with manifold outlet 50. Thus, when rotary valve 22 is in the second position, nozzle 52 may deposit the flowable confectionery present in the cylinder into a mold as is commonly known in the art. Manifold 20 and rotary valve 22 are configured so that the transferring and dispensing of confectionery product occur independently of each other. For example, when rotary valve 22 is in the first or transfer position, dispensing passage 48 is not in fluid communication with cylinder 28. Consequently, no confectionery product is dispensed or deposited from manifold 20 when rotary valve 22 is in the first position. In a similar manner, when rotary valve 22 is in the second, or depositing position, transfer passage 46 is not in fluid communication with cylinder 28 or inlet 30. Thus, no confectionery product is transferred when rotary valve is in the second position.

In an embodiment, a piston 54 is in operative engagement with a respective cylinder 28 as shown in FIGS. 2-4, 8 and 11. A piston shaft 56 extends through cylinder opening 35 and is operatively connected to a power source (not shown). Piston shaft 56 moves a piston head 58 in an up and down motion within the interior area of cylinder 28 as is commonly known in the art. A controller (not shown) may be operatively connected to driving arm 38 and the piston power source to coordinate or otherwise synchronize the movement of piston 54 and rotation of rotary valve 22.

In an embodiment, piston 54 may be moved in an upward direction when rotary valve 22 is in the first position as shown by arrow B in FIGS. 8 and 9. The upward motion of piston 54 creates a negative pressure within cylinder 28 which draws or otherwise transfers an amount of flowable confectionery product from source 12, through inlet opening 36 into inlet 30 through transfer passage 46, through bore 32 and into the interior volume of cylinder 28. Piston 54 may subsequently be moved in a downward direction when rotary valve is moved to the second position as shown by arrow C in FIG. 11. The downward motion of the piston forces the flowable confectionery product out of cylinder 28, through bore 32, through dispensing passage 48 and out of manifold 20 through manifold outlet 50. The amount of confectionery dispensed may vary corresponding to the distance piston head 58 is downwardly moved. If the downward distance of the piston is less than the upward distance of the piston, the amount of confectionery deposited will be less than the amount of confectionery transferred into the cylinder. In an embodiment, the length of the distance piston head 58 is moved in the upward direction and the downward direction is substantially equal so that the transferred amount of confectionery is substantially equal to the deposited amount of confectionery.

In an embodiment, a small gap D may be present between the exterior circumferential surface of piston head 58 and the interior circumferential surface of cylinder 28 as is shown in FIGS. 8, 9 and 11. Gap D, as best seen in FIG. 11, may have a length from about 0 mm to about 0.05 mm in length. In an embodiment, the length of the gap is from about 0.006 mm to about 0.035 mm. In a further embodiment, the gap has no length and no gap exists between the piston head outer surface and the cylinder inner surface. Teflon® or any other suitable friction-reducing material may be used to coat the piston head outer surface and/or the cylinder inner surface to maintain the tight fit between piston head and cylinder while simultaneously reducing friction therebetween.

The small length of gap D or the absence of the gap altogether and the concomitant tight fit between piston head 58 and the inner surface of cylinder 28 enables apparatus 10 to deposit confectionery product with a high degree of accuracy. Piston head diameter (and cylinder diameter), stroke length, and confectionery density may be varied as desired to deposit confectionery product with a high degree of precision. An advantage of the present invention is that the only significant factor influencing variance between deposit runs or batches is stroke variance. Consequently, the present invention provides deposited confectionery product or articles having a weight variance between successive deposit amounts from about 0.01% to 1% with successive deposit amounts typically experiencing less than 0.6% weight variance. This is a substantial improvement over conventional confectionery depositing systems which typically experience weight variance from about 10% to about 20% or more.

Not wishing to be bound by any particular theory, the significant improvement in depositing precision provided by the present invention may be partially due to the avoidance of a gravity feed system by the present invention. Conventional gravity-fed confectionery depositors require a wide tolerance between the piston head and the inner cylinder surface in order to provide adequate space for confectionery to flow into the cylinder. Removal of the piston head from the cylinder chamber during conventional piston upstroke further contributes to high weight variance between successive deposit amounts. Moreover, the presence of openings in the cylinder walls for confectionery product inflow further contributes to the low accuracy of current systems. Conventional gravity-fed depositors also require dwell time to allow the flowable confectionery to enter the cylinder. The present invention eliminates dwell time as the closed pressure-feed system requires very little time to fill the cylinder with confectionery. The tight fit between the piston head and the inner cylinder surface, the closed pressure-fed confectionery delivery system, and the rotary valve each contribute to provide a confectionery depositing apparatus with exceptional accuracy.

Rotary valve 22 also contributes to the accuracy of the amount of confectionery deposited by apparatus 10. It is commonly known in the art that once the flowable confectionery is deposited from the nozzle, a small amount of confectionery product, known as a tail, may remain suspended from the nozzle outlet. This tail may eventually fall into the formed confectionery article. The tail may also remain on the nozzle to be deposited during the next deposit cycle. Either event may cause undesired disparity between the weight, size and appearance of the finished confectionery article. In addition, the tail may further deleteriously impact the surface texture of the finished article and any coating layer in particular.

In an embodiment of the present invention, the pistons may be moved in the first upward direction a short distance once the confectionery product is discharged from each cylinder. This is performed while the rotary valve is in the second or dispensing position. In this manner, the tail may be pulled into the transfer passage of the rotary valve thereby preventing the tail from adversely affecting the confectionery article formed.

Alternatively, the movement of the pistons in the downward direction may be synchronized with returning the rotary valve to the first position. Immediately upon completion of depositing the confectionery product from the cylinder, the rotary valve may be moved back to the first position to prevent formation of the tail altogether. In a further embodiment, movement of the rotary valve from the second or depositing position back to the first or transfer position may be coordinated with the small movement of the piston in the upward direction to ensure capture of the tail within the transfer passage.

In a further embodiment of the present invention, apparatus 10 may be configured to deposit more than one flowable confectionery product in order to produce a laminated confectionery article. Apparatus 10 may be adapted to dispense a plurality of flowable confectionery products. The number of cylinders, inlets, bores, ducts may be increased to provide an increased number of layers for the confectionery article as desired. In addition, rotary valve 22 may be adapted to include multiple transfer and dispensing passages to transfer and dispense multiple flowable confectionery products. For example, FIG. 7 shows rotary valve 22 having two transfer passages 46 and two dispensing passages 48.

In this embodiment, a first flowable confectionery 60 (indicated by diagonal hash marks) contained in source 12 and a second flowable confectionery product 62 (indicated by small circles) contained in source 14 may be transferred to cylinders 28a and 28b respectively as shown in FIGS. 8 and 9. Upward motion of the pistons indicated by arrows B transfers the first flowable confectionery product 60 from source 12 and the second flowable confectionery product 62 from source 14 through bores 32a and 32b into cylinders 28a and 28b respectively through inlets 30a and 30b and ducts 34a and 34b respectively when rotary valve 22 is in the first or transfer position as previously discussed. FIG. 9 illustrates the fluid communication between cylinders 28a, 28b and inlets 30a and 30b respectively. Transfer passages 46a and 46b respectively provide this fluid communication with placement of rotary valve 22 in the first position.

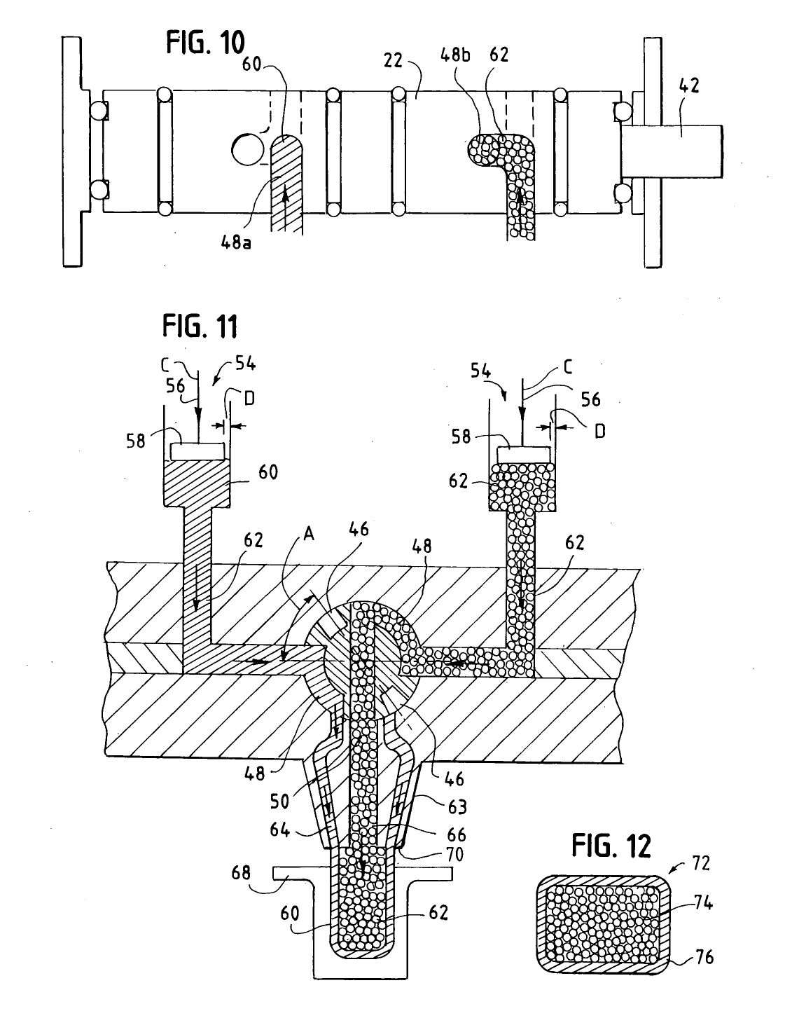

FIGS. 10 and 11 schematically illustrate the rotary valve in the second or depositing position. Downward motion of the pistons in each cylinder as indicated by arrows C subsequently dispenses first and second confectionery 60 and 62 from cylinders 28a and 28b respectively into a coextrusion nozzle 63 when rotary valve 22 is in the second or depositing position as previously discussed. Coextrusion nozzle 63 includes an outer outlet 64 and an inner outlet 66. Inner and outer outlets 64 and 66 are brought into fluid communication with cylinder 28a and 28b respectively by dispensing passages 48a, 48b respectively (FIG. 10) when rotary valve 22 is in the second position. Thus, nozzle 63 deposits first confectionary 60 through outer outlet 64 and second confectionery 62 through inner outlet 66 when rotary valve is in the second position. Nozzle 63 deposits first and second confectioneries 60 and 62 substantially simultaneously thereby coextruding first confectionery 60 with second confectionery 62 to form a coextruded or otherwise laminated confectionery article. In an embodiment, first confectionery 60 encases second confectionery 62 as the two confectioneries are coextruded from nozzle 63 as shown in FIG. 11.

In an embodiment, nozzle 63 deposits streams of first and second confectioneries 60 and 62 into a mold 68 as shown in FIG. 11. In this embodiment, nozzle 63 simultaneously coextrudes confectionery streams 60 and 62. Outlets 64 and 66 may be in a side-by-side arrangement to produce a layered confectionery article. Alternatively, outlets 64 and 66 may be concentric with respect to each other so that confectionery stream 60 from outer outlet 64 encases confectionery stream 62 from inner outlet 66.

In an embodiment, nozzle 63 and mold 68 are configured so that the length of the diameter of mold 68 is substantially the same as the length of the diameter of nozzle end 70. This arrangement prevents swirling or commingling of the confectionery streams 60 and 62 during deposit into mold 68. Provision of mold 68 having substantially the same diameter of nozzle end 70 thereby enables the stream of coextruded first confectionery 60 to encase or otherwise completely surround the stream of coextruded second confectionery 62 to form a wholly coated confectionery article. Alternatively, the diameter of mold 68 may be greater or less than the diameter of nozzle end 70 to form a multi-layered confectionery article having a spiraled, curled, swirled or otherwise textured appearance.

The respective pistons associated with and in operative engagement with cylinders 28a and 28b may be configured to move at different rates during coextrusion of first and second confectioneries 60 and 62 (i.e., when rotary valve 22 is in the second position). FIG. 11 shows confectionery 62 being deposited at a faster rate than confectionery 60 as the piston in cylinder 28b is lower than the piston in cylinder 28a. This varies the amount of first confectionery 60 that is coextruded or otherwise deposited with second confectionery 62. Moreover, varying the rates of the downward piston motion thereby enables apparatus 10 to produce a coextruded laminated confectionery article having layers of varying thickness. In an embodiment, the rates of the piston upstroke may be adjusted so that a different amount of first confectionery 60 is transferred into cylinder 28a when compared to the amount of second confectionery 62 transferred into cylinder 28b. The skilled artisan will further appreciate that the deposit amounts of the first and second confectioneries may also be varied by 1) utilizing different piston diameters for each flowable confectionery, 2) applying different stroke lengths to each flowable confectionery, and 3) utilizing a combination of different piston diameters and different stroke lengths.

A further advantage of the present invention is that the provision of the tight tolerance between piston head 58 and the inner surface of cylinder 28 enables apparatus 10 to accurately deposit small amounts of flowable confectionery. By adjusting the upward distance traveled by the piston as well as the piston downward rate of motion, apparatus 10 may produce coextruded confectionery articles having very thin layers. For example, the piston in operative engagement with cylinder 28a may be configured to move only a short upward distance to transfer a small amount of first confectionery 60 into cylinder 28a compared to the upward distance traveled by the piston associated with cylinder 28b. Moreover, the downstroke piston rate for the piston in operative engagement with cylinder 28a may be slower than the downstroke piston for the piston in operative engagement with cylinder 28b in order to form a confectionery article having a thin uniform outer coating of first confectionery 60 that surrounds a larger inner core of second confectionery 62. The nozzle outlet size and the piston downstroke may be adjusted to deposit very thin single or multiple confectionery layers having substantially uniform thickness. In an embodiment, apparatus 10 may be used to produce confectionery layers having a thickness from about 0.05 mm to about 2.0 mm.

In another embodiment, the present invention provides a confectionery article 72 produced by apparatus 10. Confectionery article 72 includes a core 74 and a coating 76 as shown in FIG. 12. Coating 76 is coextruded to core 74 as previously discussed. Thus, coating 76 may be composed of first flowable confectionery 60 and core 74 may be composed of second flowable confectionery 62. Core 76 may be any confectionery product that is capable of being coated as is commonly known in the art. Nonlimiting examples of materials suitable for core 74 include hard candy, soft candy, chewing gum, jellies, gums, caramel, nut paste, gelatins, fondants, nougats, chocolate, toffee, taffy and any combination thereof. Coating 76 may be any confectionery product that is capable of coating another confectionery product as is commonly known in the art. Nonlimiting examples of materials suitable for coating 76 include hard candy, soft candy, chewing gum, jellies, gums, caramel, nut paste, gelatins, fondants, nougats, chocolate, toffee, taffy and any combination thereof.

The composition of core 74 and coating 76 may be the same or different. In an embodiment, coating 76 is a different confectionery product than core 74. In a further embodiment, coating 76 is substantially continuous and completely encases or otherwise covers or surrounds the entirety of core 74. In a further embodiment, coating 76 has a uniform thickness.

An advantage of the present invention is the capability of apparatus 10 to accurately deposit as well as coextrude uniform layers of flowable confectionery product. The tight tolerance between each piston and respective cylinder provides apparatus 10 with a high degree of accuracy 1) for depositing relatively small amounts of confectionery and 2) for controlling the rate at which the confectionery is deposited. Thus, laminated confectionery articles produced by apparatus 10 may exhibit fine, thin coextruded layers and/or coatings having a uniform thickness. In an embodiment, coating 76 coextruded to core 74 may be present in an amount from about 5% to about 30% by weight of the confectionery article. In a further embodiment, coating 76 may constitute from about 5% to about 10% by weight of the confectionery article. In yet a further embodiment, coating 76 may be from about 0.05 mm to about 2.0 mm thick and has a substantially uniform thickness about the entire confectionery article.

Although FIG. 12 illustrates a confectionery article having a core coated with a single coating, the skilled artisan will appreciate that laminated products with multiple coextruded layers may be produced in accordance with the present invention. For example, laminated confectionery products having three, four, five, six or more coextruded layers may be produced by apparatus 10. Furthermore, non-coated laminated confectionery articles are also within the scope of the present invention. Apparatus 10 may be adapted to deposit coextruded streams of flowable confectionery in a layered manner to produce a coextruded multi-layered confectionery article. Alternatively, the layers of confectionery product may be deposited to produce a confectionery article having a swirled appearance.

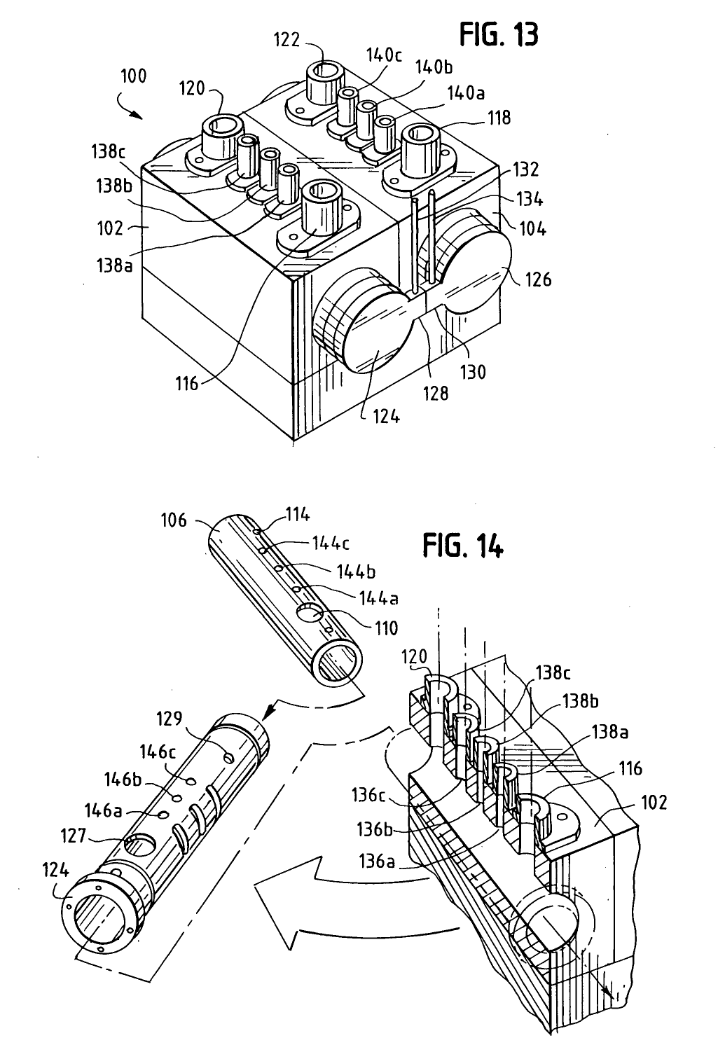

FIGS. 13-16 depict a further embodiment of the present invention wherein a confectionery depositor apparatus 100 includes manifolds 102 and 104 with respective passageways 106 and 108 disposed therein. Passageways 106 and 108 are tubular or annular in shape and include an inner surface for accommodating a flow of fluid confectionery and an outer surface as is commonly known in the art. It is understood that apparatus 100 may have from one to about three, five, or ten or more manifolds as desired.

The passageways each include a respective fluid confectionery inlet and an outlet. Passageway 106 has an inlet 110 and an outlet 114 as shown in FIG. 14. Passageway 108 has a similar inlet and outlet. One of ordinary skill in the art will appreciate that description directed to manifold 102 and the components therein applies equally to manifold 104 and the components of manifold 104. The inlets of each passageway are aligned with respective manifold inlets 116, 118 to establish fluid communication therewith. Similarly, each passageway outlet is aligned or otherwise positioned to provide fluid communication with respective manifold outlets 120 and 122. As shown in FIGS. 13 and 14 for example, passageway 106 includes inlet 110 that is aligned with manifold inlet 116. Passageway 106 also includes outlet 114 that is positioned to be in fluid communication with manifold outlet 120.

Each manifold inlet 116, 118 may be placed in fluid communication with a source of fluid confectionery (not shown) with piping or tubing as is commonly known in the art. In an embodiment, a pump (not shown) may be placed in operative communication with the fluid confectionery source and the manifold inlet to deliver a flow of fluid confectionery into the passageway. In a further embodiment, the manifold outlet is placed in fluid communication with the source of fluid confectionery to provide a closed system. In this configuration, the pump may be used to deliver the fluid confectionery through the manifold and passageway inlets, into and through the passageway, out through the manifold and passageway outlets and back to the fluid confectionery source.

A closed system is advantageous in several respects. A closed system protects the fluid confectionery from contamination. A closed system also permits the recycle or reuse of any fluid confectionery remaining in the passageway after completion of a depositing cycle (as will be discussed in detail below). Indeed, an advantage of the present invention is that the closed system, and the flow-through passageway in particular, reduces or altogether eliminates evaporation of fluid confectionery during the confectionery depositing process. Equally advantageous is that the closed system/flow-through passageway arrangement prevents the escape or evaporation of any volatile flavors or fragrances typically included in the fluid confectionery.

Rotary valves 124, 126 surround respective passageways 106 and 108 as shown in FIGS. 14-16. The breakaway exploded view provided by FIG. 14 illustrates the relationship between manifold 102, rotary valve 124 and passageway 106. It is understood that the description of manifold 102 applies equally to manifold 104, rotary valve 126 and passageway 108. One of ordinary skill in the art will recognize that the term “surround” or “surrounding” means that each rotary valve encases, encircles, or otherwise encompasses the outer surface of at least a portion of the respective passageway. In an embodiment, the cross-section of each passageway and each rotary valve is substantially circular in shape. This enables the rotary valve to circumferentially surround or encircle the entire circumference of the passageway outer surface. In other words, the rotary valve may surround, encircle or encase an outer circumferential surface of the passageway. In a further embodiment, the rotary valve is concentrically disposed around at least a portion of the passageway length. Alternatively, the rotary valve may have a non-circular cross-sectional shape, such as a semi-circle or a c-shape, for example. In yet a further embodiment, the rotary valve rotates around or about the passageway. In other words, the rotary valve rotates about the axis defined by the passageway.

Rotary valve 124 also includes intake orifice 127 that is aligned to permit fluid communication between passageway inlet 110 and manifold inlet 116. Rotary valve 124 further includes outlet orifice 129 that is aligned to permit fluid communication between passageway outlet 114 and manifold outlet 120.

In another embodiment, the circumference of the outer passageway surface may be constant along substantially the entire passageway length, while the circumference of the passageway inner surface may decrease between the inlet and the outlet. This provides the passageway inner surface with a tapered shape, or alternatively, an elongated frustoconical shape in the direction of fluid flow-from inlet to outlet. Such a tapered inner passageway surface (i.e., a large passageway cross section near the inlet and a smaller passageway cross section near the outlet) may be advantageous in promoting a constant confectionery flow throughout the entire length of the passageway. In a further embodiment, a heating element may be disposed proximate the passageway. The heating element may be disposed between the inner surface of the rotary valve and the passageway outer surface. Alternatively, the heating element may be disposed along the external surface of the rotary valve or within the manifold. In an embodiment, the heating element maintains the temperature of the fluid confectionery flowing through the passageway from about 100° C. to about 150° C.

Each rotary valve 124, 126 is attached to a respective arm 128, 130. Each arm is attached to a respective rod 132, 134 that is propelled in an upward and downward motion by a power source (not shown) as is commonly known in the art. The same or different power source may be used to drive arms 132, 134. The upward and downward motion of the rods moves the respective arms to drive or otherwise move each rotary valve between a first position and a second position. In an embodiment, a lubricant may be introduced between the inner surface of the rotary valve and the outer surface of the passageway to reduce friction therebetween. In another embodiment, a sleeve made of TEFLON® or the like may be placed between the outer passageway surface and the inner valve surface to promote rotation of the rotary valve about the passageway.

Manifold 102 includes bores 136a, 136b and 136c adapted to place respective piston and cylinder assemblies 138a, 138b and 138c into fluid communication with passageway 106. Piston and cylinder assemblies 140a, 140b, and 140c are placed in fluid communication with passageway 108 in a similar manner with bore 142 placing piston and cylinder assembly 140a into fluid communication with passageway 108 as shown in FIG. 16. Each manifold may utilize as few as one to as many as three, five 10, 20, 30 or more piston and cylinder assemblies as previously discussed.

Passageway apertures 144a, 144b, 144c disposed on passageway 106 are aligned with bores 136a-c respectively. When rotary valve 124 is placed in the first position, intake passages 146a, 146b, 146c of rotary valve 124 align with bores 136a-c respectively and passageway apertures 144a-c respectively to place passageway 106 in fluid communication with piston and cylinder assemblies 138a, 138b, 138c. Similarly, when rotary valve 108 is placed in its respective first position, intake passage 147 of passageway 108 is moved between passageway aperture 145 and bore 142 thereby placing passageway 108 in fluid communication with piston and cylinder assembly 140a.

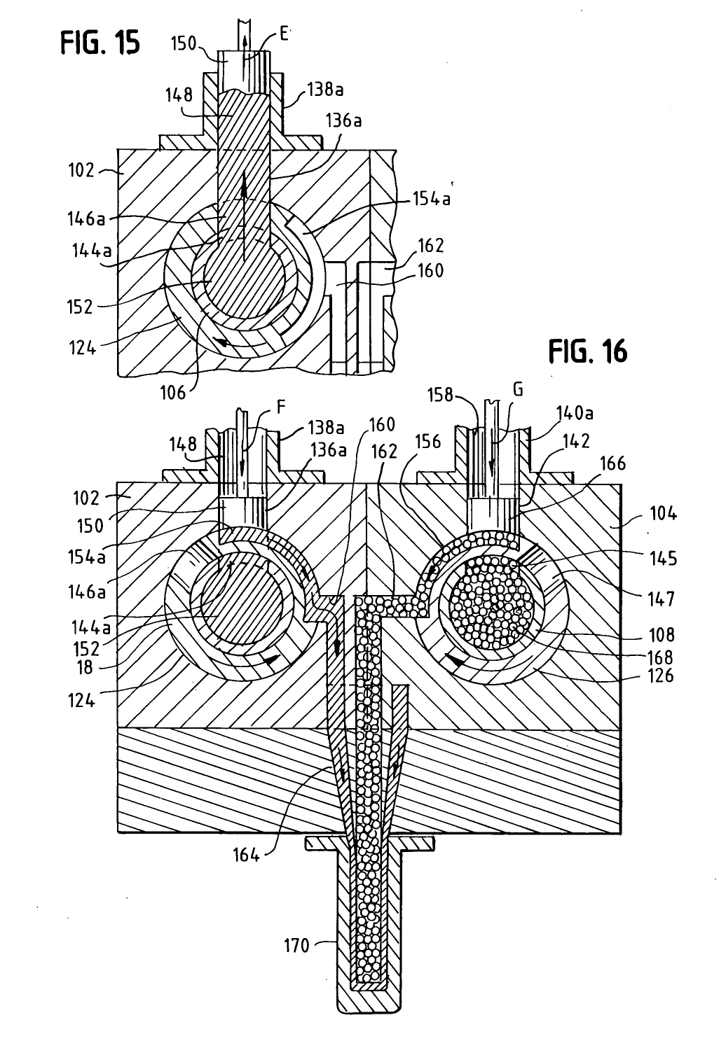

FIG. 15 shows rotary valve 124 in the first position whereby intake passage 146a is moved into place between bore 136a and passageway aperture 144a to place passageway 106 in fluid communication with cylinder chamber 148. While rotary valve 124 is in the first position, an upstroke denoted by direction arrow E of a piston 150 transfers an amount of fluid confectionery 152 through passageway aperture 144a, through rotary valve intake passage 146a, through bore 136a and into cylinder chamber 148. The upstroke length may be adjusted to transfer a desired amount of fluid confectionery as previously discussed. It is understood that movement of rotary valve 126 to the first position and subsequent piston upstroke transfers fluid confectionery from passageway 108 to piston and cylinder assemblies 140a-c in a similar manner.

Each rotary valve further includes a dispensing channel for dispensing the fluid confectionery transferred into the cylinder chamber. The number of dispensing channels disposed upon the rotary valve typically corresponds to the number of piston and cylinder assemblies present in the manifold. For example, FIG. 14 shows dispensing channels 154a, 154b, and 154c that correspond to piston and cylinder assemblies 138a-c. Thus it is understood that the following description of a single dispensing channel in each manifold applies equally to other dispensing channels disposed upon the rotary valve.

Upon completion of upstroke E, rotary valves 124, 126 are moved to the second position as shown in FIG. 16. This places one end of dispensing channels 154a, and 156 of respective rotary valves 124 and 126 in fluid communication with respective cylinder chambers 148 and 158. Placement of rotary valves 124, 126 in the second position also places a second end of each respective dispensing channel in fluid communication with a respective duct 160 and 162. Ducts 160 and 162 are in fluid communication with a dispensing nozzle. In an embodiment, the dispensing nozzle is a coextrusion dispensing nozzle 164 as shown in FIG. 16.

Downstroke F of piston 150 dispenses the first fluid confectionery 152 from cylinder chamber 148 through dispensing channel 154a, through duct 160 and into nozzle 164. Downstroke G of piston 166 dispenses a second fluid confectionery 168 from cylinder chamber 158 through duct 162 and into nozzle 164. In an embodiment, nozzle 164 simultaneously dispenses first and second fluid confectioneries 152 and 168 into a separate confectionery mold 170. In a further embodiment, the amount of fluid confectionery transferred into the cylinder chamber is substantially equal to the amount of fluid confectionery dispensed from the apparatus. The rate and magnitude of downstrokes F and G may adjusted to vary the amounts of the first and second confectioneries present in the final confectionery article as desired. The final confectionery article may be laminated or encapsulated as previously discussed.

Rotary valve 124 may be designed so that intake orifice 127 may or may not permit fluid communication between inlet 110 and manifold inlet 116 when rotary valve 124 is in the first or second position as desired. Rotary valve 124 may similarly be configured so that outlet orifice 129 may or may not permit fluid communication between outlet 114 and manifold outlet 120 when rotary valve 124 is in either the first or second position. In an embodiment, rotary valve 124 is designed to prevent flow of fluid confectionery into inlet 110 when the rotary valve is in the first position. Rotary valve 126 may be designed in a similar manner. The diameter of the cylinder chamber and piston head may be varied as desired to vary the thickness of each coextruded layer of confectionery product. One of ordinary skill in the art will appreciate that the diameter for the corresponding bore, passageway aperture, valve intake passage, dispensing channel, duct and nozzle may likewise be adjusted to accommodate the diameter of the cylinder chamber. Tables 1 and 2 provide several examples whereby the piston diameter (and cylinder diameter) are varied to produce a laminated confectionery article with laminate layers of varying thickness.

The fluid confectionery flow rate within the passageway may be adjusted in order ensure that a sufficient amount of fluid confectionery is present in the passageway before and during the depositing cycle (the depositing cycle being 1) valve rotation to the first position, 2) piston upstroke, 3) valve rotation to second position, 4) piston downstroke). In an embodiment, from about 95% to about 99% of the fluid confectionery present in the passageway is deposited from apparatus 100 upon completion of the depositing cycle. The amount of fluid confectionery remaining in the passageway after the depositing cycle may be delivered with the pump out of the manifold inlet to the source of fluid confectionery. This allows the unused fluid confectionery to be used in a subsequent depositing cycle. One of ordinary skill in the art will appreciate that the flow rate may vary to account for the length of the passageway, the density and/or the viscosity of the fluid confectionery and the number of piston and cylinder assemblies present in apparatus 100. In a further embodiment, the flow rate of the fluid confectionery through the passageway is adjusted to ensure that no air bubbles or other gasses are present in the fluid flow system. Elimination of air or gas in the system increases depositing and accuracy and reproducibility.

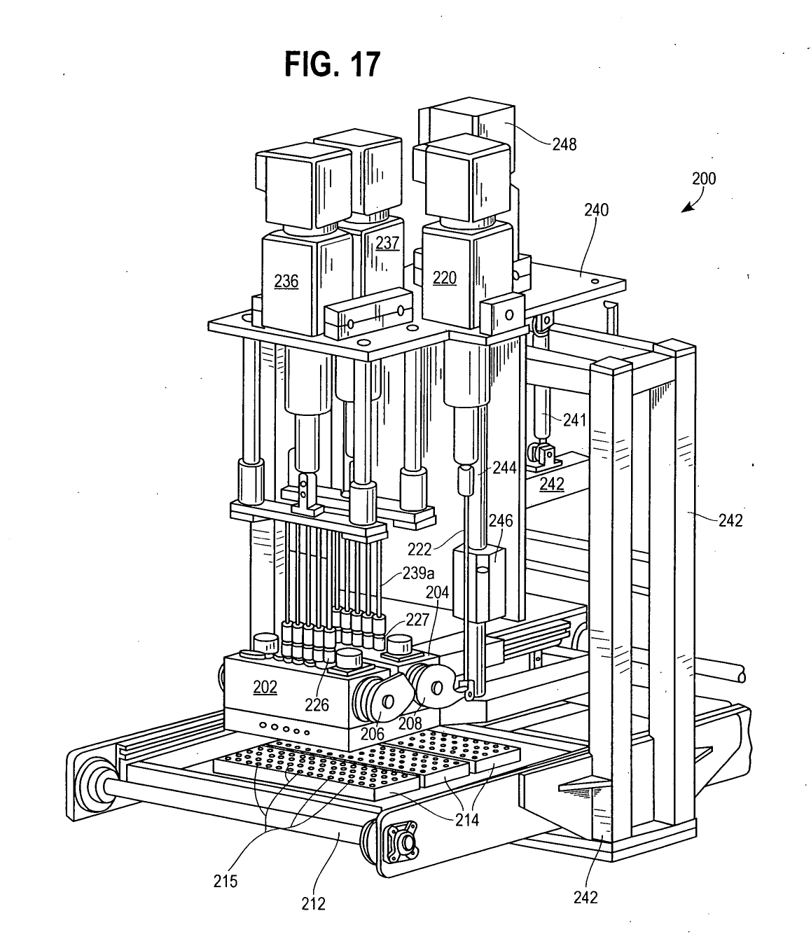

FIGS. 17-21 depict a further embodiment wherein a confectionery depositor apparatus 200 includes a fluid confectionery source, manifolds 202, 204, rotary valves 206, 208, a dispensing outlet 210, and a conveyor 212 for moving a tray 214 under dispensing outlet 210. Conveyor 212 has a belt or similar device and a drive mechanism as commonly known in the art so as to move tray 214 or a plurality of trays 214 under dispensing outlet 210 in a continuous manner.

In an embodiment, the fluid confectionery source is a passageway for accommodating a flow of fluid confectionery similar to passageways 106, 108 (FIGS. 14-16). In this embodiment, the rotary valve surrounds the passageway to dispense fluid confectionery therefrom as previously described. Alternatively, the fluid confectionery source may be a hopper type source such as sources 12, 14 with the rotary valve disposed in a manifold below the fluid confectionery source as shown in FIG. 1, for example.

Although FIGS. 17-21 show apparatus 200 having two manifolds, one of ordinary skill in the art will appreciate that the operation and components of a single manifold apply equally to both manifolds. Indeed, apparatus 200 may include a single manifold without detracting from scope of the present invention. It is therefore understood that the following discussion of manifold 202, and the components associated therewith applies equally to manifold 204 and its associated components.

Rotary valve 206 is in fluid communication with the fluid confectionery source (i.e., the passageway within manifold 202), rotary valve 206 being rotatable to a fluid confectionery dispensing position as previously discussed. Rotary valve 206 is also in fluid communication with dispensing outlet 210. Placing rotary valve 206 in the dispensing position enables fluid confectionery to be dispensed from apparatus 200 through dispensing outlet 210.

In an embodiment, the rotation of the rotary valve and movement of the tray by way of the conveyor is coordinated. As used herein, the term “coordinate” or “coordinated” means to integrate or otherwise organize the movement of different components into a common, unified action, namely the dispensing of fluid confectionery into the tray. Thus, by “coordinating” the movement of components or the steps in the depositing process, the operation of individual components or the accomplishment of individual tasks is arranged in a systematic manner to yield an orderly, coherent, harmonious, and seamless confectionery depositing process. Accordingly, the coordinated movement between components (or coordinated steps in the dispensing process) may be sequential wherein the movement of one component is performed and completed before the initiation and performance of a different component.

The movement between operating components (or process steps) may also be a cascading progression wherein the performance of one phase (or component performance) of operational activity overlaps a different operational phase to the extent that the completion of the first phase triggers or otherwise initiates the performance of a subsequent operational phase or phases. In addition, the operation of different components may be synchronized wherein movement of different components (or the occurrence of different process steps) occurs simultaneously or substantially simultaneously. Thus, coordination between component movement/process steps may involve sequential progression, cascading progression, synchronized operation, or any combination thereof. The coordination between component operation/process steps of the depositing process (or the movement of components) may be performed either automatically or manually.

In an embodiment, a controller 216 (FIG. 21) in operative communication with rotary valve 208 and conveyor 212 automatically coordinates the rotation of rotary valve 208 to the dispensing position with the movement of tray 214 to a fluid confectionery receiving position 218 underneath dispensing outlet 210. Controller 216 may be any controlling device commonly known in the art such as a programmable logic controller or similar device, for example. Operative communication between controller 216 and rotary valve 208 and conveyor 212 may be by way of such nonlimiting examples as electrical connection, mechanical connection, Internet connection, Bluetooth connection, RF frequency connection, optical connection, IR connection and the like.

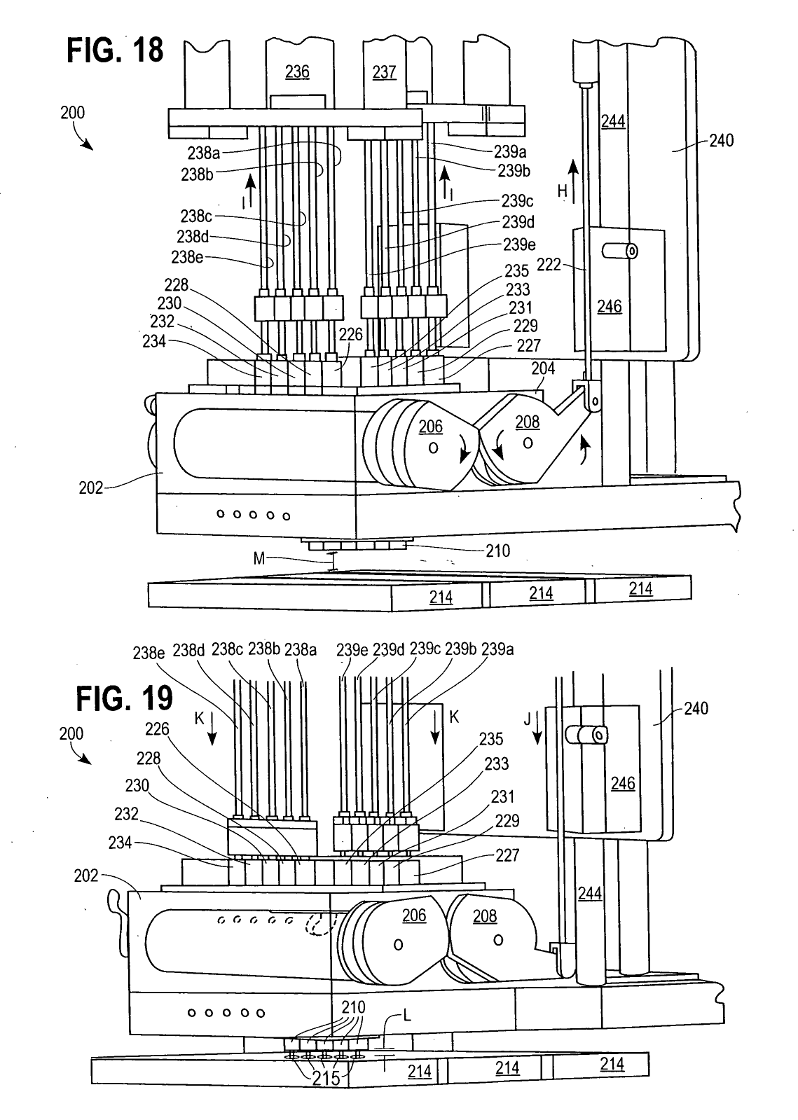

In an embodiment, actuator 220 is in operative communication with controller 216 and rotary valve 208. Actuator 220 may be any type of drive mechanism that may be adapted to receive a signal from controller 216 and perform a driving motion in response to the signal generated by the controller as is commonly known in the art. Nonlimiting examples of suitable actuators include electric drive mechanisms, hydraulic drive mechanisms, pneumatic drive mechanisms, mechanical drive mechanisms, and gearboxes. In an embodiment, Actuator 220 may be a servo motor. Actuator 220 also includes an arm 222 which is moved in an up and down manner to rotate rotary valve 208 as shown in FIGS. 18 and 19. The adjacent arrangement of manifolds 202 and 204 enables the rotation of rotary valve 208 (by way of arm 222) to also drive or otherwise rotate rotary valve 206. It is understood that actuator 220 and arm 222 may be placed in direct operative communication with rotary valve 206 when the apparatus includes a single manifold and a single rotary valve configuration. An actuator 224 may be in operative communication with controller 216 and conveyor 212 in a similar manner, actuator 224 being any type of drive mechanism suitable for driving conveyor 212 as is commonly known in the art.

Controller 216 may coordinate or otherwise direct the rotation of rotary valves 206 and 208 and the movement of tray 214 in any desired manner. For example, rotation of rotary valves 206 and 208 may occur either before, during, or after the movement of tray 214 into fluid confectionery receiving position 218. In other words, the rotation rotary valves 206 and 208 may occur sequentially either before or after movement of tray 214 to dispensing position 218; rotary valve 206, 208 rotation may occur in a cascading progression with movement of tray 214 to dispensing position 218; or rotary valve 206, 208 rotation may be synchronized with movement of tray 214 to dispensing position 218.

In a further embodiment, apparatus 200 includes piston and cylinder assemblies 226, 228, 230, 232, and 234 that are in fluid communication with rotary valve 206 and piston and cylinder assemblies 227, 229, 231, 233, and 235 that are in fluid communication with rotary valve 208. Although FIGS. 17-21 depict manifolds 202 and 204 having five piston and cylinder assemblies, the skilled artisan will appreciate that the number of piston and cylinder assemblies may vary from one to five, 10, 20 or 25 or more as previously discussed. As shown in FIG. 18, rotary valves 206, 208 are rotatable to an intake position by an upward motion of actuator arm 222 (denoted by up arrow H) whereby a piston upstroke (denoted by up arrow I) transfers an amount of fluid confectionery from each respective passageway into the cylinders as previously discussed. In an embodiment, an actuator 236 is in operative communication with controller 216 and piston shafts 238a, 238b, 238c, 238d, and 238e to drive the piston shafts in an up and down manner when directed by controller 216. An actuator 237 is in operative communication with controller 216 and piston shafts 239a, 239b, 239c, 239d, and 239e to drive these piston shafts in a similar manner.

Controller 216 may then coordinate the piston upstroke with the rotation of valve 206 and movement of tray 214 (vis-à-vis conveyor 212) in any desired manner. For example, controller 216 may coordinate the piston upstroke to occur at a time period either before, during, or after movement of tray 214 to confectionery receiving position 218. Thus, controller 216 may coordinate rotation of rotary valves 206, 208, movement of tray 214, and the upstroke of pistons 238a-e and 239a-e sequentially, in a cascading progression, in a synchronized manner or in any combination thereof.

With an amount of fluid confectionery present in the cylinder, controller 216 generates a signal to actuator 220 and directs rotary valves 206, 208 to rotate to the dispensing position by a downstroke of arm 222 (indicated by arrow J), whereby a piston downstroke (indicated by arrow K) dispenses the amount of fluid confectionary from each cylinder, through rotary valves 206 and 208 and out of dispensing outlets 210 as shown in FIG. 19. The dispensing position of rotary valve 206 is apparent as the rotary valve intake passages (shown in phantom) are moved out of fluid communication with the respective cylinders as shown in FIG. 19. This indicates that each cylinder is in fluid communication with respective dispensing channels as previously discussed. The amount of dispensed fluid confectionery is subsequently received by tray 214. It is understood that tray 214 has an appropriate number of receptacles 215 to accommodate and correspond to the number of dispensing outlets present on apparatus 200 when tray 214 is moved to dispensing position 218. In addition, the size of tray 214 may be varied as desired to include as few as one receptacle to as many as five, 10, 20, 50, 100 or more receptacles as is commonly known in the art. The dimensions (height, width, depth) and shape (circle, oval, spherical, oblong, cube, etc.) of each receptacle 215 may also be varied as desired.

The confectionery article formed in tray 214 may be a single component article (i.e., when a single fluid confectionery is deposited from an apparatus having a single rotary valve and/or a single fluid confectionery source), or a coextruded or laminated article as previously discussed. Consequently, the first and second amounts of fluid confectionery may be dispensed substantially simultaneously, and/or coextruded. The first and second amounts of fluid confectionery may be dispensed so that one amount encases or otherwise surrounds the other amount to form an encased confectionery article as previously discussed.

In an embodiment, controller 216 may generate a signal to direct actuators 236, 237 to perform a slight piston upstroke immediately after the fluid confectionery is received by tray 214. This piston upstroke occurs while rotary valves 206, 208 are in the dispensing position. The piston upstroke draws any fluid confectionery dangling from outlets 210 back into apparatus 200. Performance of this small upstroke is advantageous in reducing or otherwise eliminating tailing of the fluid confectionery within each tray receptacle.

In a further embodiment, apparatus 200 includes a base 240 upon which manifolds 202, 204 and actuators 220, 236 and 237 are attached. A drive mechanism 241 is attached to base 240 and support 242. Drive mechanism 241 may be any drive device capable of moving base 240 in an up and down manner relative to support 242 as previously discussed. The motion provided by drive mechanism 241 in conjunction with the cooperative engagement of posts 244 and guides 246 enables precise movement of outlet 210 relative to tray 214. One of ordinary skill in the art will appreciate that the base and support may be arranged to allow the base to move in a horizontal manner, if desired.

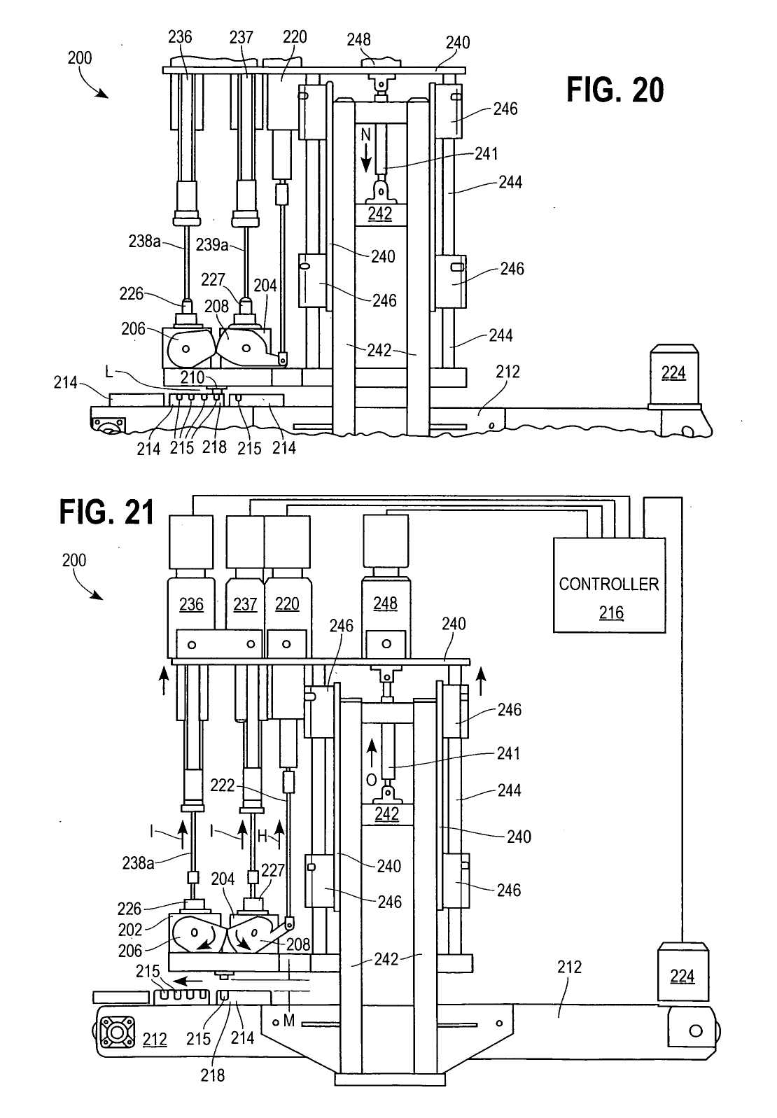

In an embodiment, an actuator 248 may be placed in operative communication with controller 216 and drive mechanism 241 to bring base 240 and thereby apparatus 200 to a depositing position L at the direction of controller 216. Depositing position L is in cooperative relation or otherwise aligned with fluid confectionery receiving position 218. Typically, depositing position L is determined by bringing base 240 downward toward conveyor 212 so that the end of dispensing outlet 210 is from about 0 inches to about 1 inch, and preferably ¼ inch, away from the top surface of tray 214. Apparatus 200 is brought to position L by directing drive mechanism 241 to move base 240 downward as indicated by arrow N in FIG. 20. In other words, depositing position L may be otherwise defined as the position that base 240 is in so that a 0 inch (or less) to 1 inch gap exists between outlet 210 and the top surface of tray 214 as shown in FIGS. 19 and 20. It is understood that certain depositing applications may require the end of dispensing outlet 210 to extend lower than the top tray surface and into the receptacle area.

Movement of drive mechanism 241 in an upward direction as indicated by arrow 0 in FIG. 21 moves base 240 and apparatus 200 to an idle position M. In the idle position, the length of gap M (i.e., the distance between the end of dispensing outlet 210 and the top surface of tray 214) may be from about ½ inch to several inches or more away from the tray top surface as shown in FIGS. 18 and 21. Fluid confectionery is typically not dispensed from outlet 210 when apparatus is in idle position M except for maintenance, troubleshooting and/or cleaning activities. Positioning apparatus 200 in idle position M may be advantageous during the movement of tray 214 to receiving position 218. Placing apparatus 200 to position M may serve as a preventative measure to ensure no inadvertent contact occurs between outlet 210 and tray 214 during movement of the tray. Indeed, the skilled artisan will appreciate that placement of apparatus 200 to idle position M during tray movement may be beneficial for depositing applications which require placement of the end of dispensing outlet 210 below the tray top surface and into the receptacle.

In an embodiment, controller 216 may be used to coordinate the rotation of rotary valves 206, 208, movement of tray 214 (via conveyor 212), the piston stroke (either upstroke or downstroke) of pistons 238a-e and 239a-e, and the bringing or otherwise positioning of apparatus 200 to the depositing position. For example, controller 216 may be used to coordinate the bringing of apparatus 200 to the depositing position at a time period before, during, or after the movement of tray 214 to receiving position 218. The positioning of apparatus 200 to depositing position L may be further coordinated to occur at a time period before, during, or after rotation of rotary valve 206 as well as before, during, or after a piston upstroke/downstroke. Moreover, the operational activities of valve rotation, tray movement, piston stroke, and placement of the apparatus to the depositing position may occur in sequential progression, cascading progression, in a synchronized manner and any combination thereof. Controller 216 may also be used to coordinate the rotation of the valves, the tray movement, piston stroke and placement of apparatus 200 to the idle position in a similar manner. It is understood that apparatus 200 may be equipped with sensors in operative communication with the controller, the sensors detecting the position and/or movement of the components to assist in the coordination of component operation. Sensors may be positioned on apparatus 200 to detect actuator, piston, and drive mechanism position and upstroke/downstroke motion; rotary valve movement/position; and tray movement/position as is commonly known in the art.

By way of example and not limitation, further description of each operational phase is provided below.

Step 1. The conveyor moves the tray to the fluid confectionery receiving position.

Step 2. The rotary valve is rotated to the intake position.

Step 3. A piston upstroke transfers an amount of fluid confectionery from the fluid confectionery source into the cylinder.

Step 4. The rotary valve is rotated to the dispensing position.

Step 5. The apparatus is brought to the depositing position.

Step 6. A piston downstroke dispenses the amount of fluid confectionery present in the cylinder through the rotary valve and out of the dispensing outlet.

Step 7. The tray receives the dispensed amount of fluid confectionery.

Step 8. (Optional) A small piston upstroke occurs while the rotary valve is in the dispensing position to prevent tailing.

Step 9. The apparatus is moved to the idle position.

One of ordinary skill in the art will appreciate that although these steps are listed numerically, the numerical indication of the steps does not necessarily correspond to the chronological order in which the steps occur during the confectionery depositing cycle. The controller may be programmed to perform any operational series as desired. It is understood that Step 6 occurs once the apparatus is placed at the depositing position (Step 5). Nonlimiting examples of the operational series for the confectionery depositing cycle are set forth below. Once the apparatus is at the depositing position, the series may be as follows:

| | Once the apparatus is at the |
|---|---|
| | depositing position, the series may be |
| | as follows: |
| 1, 2, 3, 4, 5 or 9 2, 5 or 9, 3, 4, 1 | 6, 7, 8, 9 |
| 2, 1, 3, 4, 5 or 9 2, 3, 5 or 9, 4, 1 | 6, 7, 9, 8 |
| 2, 3, 1, 4, 5 or 9 2, 3, 4, 5 or 9, 1 | 7, 8, 9 |
| 2, 3, 4, 1, 5 or 9 5 or 9, 1, 2, 3, 4 | 7, 9, 8 |
| 1, 5 or 9, 2, 3, 4 2, 3, 4, 1, 5 or 9 | |
| 5 or 9, 2, 3, 4, 1 | |
| 2, 5 or 9, 1, 3, 4 | |
| 2, 3, 5 or 9, 1, 4 | |

The above-listed series may be any combination of sequential progression, cascading progression, or synchronized operation. For example, Steps 1, 5 and 9 may occur before, during, or after a portion of any the operational activities of Steps 2-4. Alternatively, Steps 1, 5, and 9 may be synchronized with each other (or synchronized with any or all of Steps 2-4) while steps 2-4 sequentially progress or progress in a cascading manner. An advantage of the present invention is the myriad of possibilities by which the confectionery depositing process may be performed.

By way of example and not limitation, examples of the present invention will now be given.

### EXAMPLES

TABLE 1
Deposit Amount Based on Piston Diameter and Stroke Length

| | | |
|---|---|---|
| Confectionery Density (hot mass) | 1.27 | gr/cm³ |

Piston Diameter 6.00 mm.

| | | VOLUME | |
|---|---|---|---|
| STROKE (mm) | SECTION (mm2) | (cm3) | WEIGHT (g) |
| 12.00 | 28.274 | 0.339 | 0.431 |
| 30.00 | 28.274 | 0.848 | 1.077 |

Piston Diameter 7.00 mm.

| | | VOLUME | |
|---|---|---|---|
| STROKE (mm) | SECTION (mm2) | (cm3) | WEIGHT (g) |
| 12.00 | 38.485 | 0.462 | 0.587 |
| 30.00 | 38.485 | 1.155 | 1.466 |

Piston Diameter 8.00 mm.

| | | VOLUME | |
|---|---|---|---|
| STROKE (mm) | SECTION (mm2) | (cm3) | WEIGHT (g) |
| 12.00 | 28.274 | 0.339 | 0.431 |
| 30.00 | 50.265 | 1.508 | 1.915 |

Piston Diameter 9.00 mm.

| | | VOLUME | |
|---|---|---|---|
| STROKE (mm) | SECTION (mm2) | (cm3) | WEIGHT (g) |
| 12.00 | 63.617 | 0.763 | 0.970 |
| 30.00 | 63.617 | 1.909 | 2.424 |

Piston Diameter 10.00 mm.

| | SECTION | VOLUME | WEIGHT |
|---|---|---|---|
| STROKE (mm) | (mm2) | (cm3) | (g) |
| 12.00 | 78.540 | 0.942 | 1.197 |
| 30.00 | 78.540 | 2.356 | 2.992 |

Piston Diameter 11.00 mm.

| | | VOLUME | |
|---|---|---|---|
| STROKE (mm) | SECTION (mm2) | (cm3) | WEIGHT (g) |
| 12.00 | 95.033 | 1.140 | 1.448 |
| 30.00 | 95.033 | 2.851 | 3.621 |

Piston Diameter 12.00 mm.

| | | VOLUME | |
|---|---|---|---|
| STROKE (mm) | SECTION (mm2) | (cm3) | WEIGHT (g) |
| 12.00 | 113.097 | 1.357 | 1.724 |
| 30.00 | 113.097 | 3.393 | 4.309 |

Piston Diameter 13.00 mm.

| | | VOLUME | |
|---|---|---|---|
| STROKE (mm) | SECTION (mm2) | (cm3) | WEIGHT (g) |
| 12.00 | 132.732 | 1.593 | 2.023 |
| 30.00 | 132.732 | 3.982 | 5.057 |

Piston Diameter 14.00 mm.

| | | VOLUME | |
|---|---|---|---|
| STROKE (mm) | SECTION (mm2) | (cm3) | WEIGHT (g) |
| 12.00 | 153.938 | 1.847 | 2.346 |
| 30.00 | 153.938 | 4.618 | 5.865 |

TABLE 2
Confectionary Article Example 1

| CONFECTIONERY ARTICLE | | | SAME PISTON STROKE, DIFFERENT PISTON DIAMETERS (7 mm | | | | | | |
|---|---|---|---|---|---|---|---|---|---|
| EXAMPLE 1 | | | PISTON for 20% SHELL AND 14 mm PISTON for 80% CORE) | | | | | | |
| Diameter of the piston A (shell) | 7 | mm. | Tolerance | From | 7 − 0.005 | to | 7 − 0.014 | Maximum gap | 0.029 |
| | | | | | | | | acceptable | |
| Diameter of the cylinder A (shell) | 7 | mm. | Tolerance | From | 7 + 0.015 | to | 7 − 0.000 | Minimum gap | 0.005 |
| | | | | | | | | acceptable | |
| Weight of the shell (20%) | 0.600 | gr. | | | | | | | |
| Stroke of piston A | 12.27 | mm. | Volume | 0.00047 | Cubic decimeters | | | | |
| Density of the candy mass | 1.27 | Kg/dm3 | Weight | 0.600 | grams | | | | |
| Diameter of the piston B (core) | 14 | mm. | Tolerance | From | 14 − 0.006 | to | 14 − 0.017 | Maximum gap | 0.035 |
| | | | | | | | | acceptable | |
| Diameter of the cylinder B (core) | 14 | mm. | Tolerance | From | 14 + 0.018 | to | 14 − 0.000 | Minimum gap | 0.006 |
| | | | | | | | | acceptable | |
| Weight of the core (80%) | 2.400 | gr. | | | | | | | |

| | | | | | |
|---|---|---|---|---|---|
| Stroke of piston B | 12.27 | mm. | Volume | 0.00189 | Cubic decimeters |

| | | | | | |
|---|---|---|---|---|---|
| Density of the candy mass | 1.27 | Kg/dm3 | Weight | 2.400 | grams |

Volume = stroke × diameter × diameter × pi/4
Weight = Volume × density

TABLE 3
Confectionery Article Example 2

| CONFECTIONERY ARTICLE | | | SAME PISTON DIAMETER, DIFFERENT PISTON STROKES (12 mm | | | | | | |
|---|---|---|---|---|---|---|---|---|---|
| EXAMPLE 2 | | | STROKE FOR 30% SHELL AND 70% CORE) | | | | | | |
| Diameter of the piston A (shell) | 12 | mm. | Tolerance | From | 12 − 0.006 | to | 7 − 0.017 | Maximum gap | 0.035 |
| | | | | | | | | acceptable | |
| Diameter of the cylinder A (shell) | 12 | mm. | Tolerance | From | 12 + 0.018 | to | 12 − 0.000 | Minimum gap | 0.006 |
| | | | | | | | | acceptable | |
| Weight of the shell (20%) | 0.900 | gr. | | | | | | | |
| Stroke of piston A | 6.3 | mm. | Volume | 0.00071 | Cubic decimeters | | | | |
| Density of the candy mass | 1.27 | Kg/dm3 | Weight | 0.900 | grams | | | | |
| Diameter of the piston B (core) | 12 | mm. | Tolerance | From | 12 − 0.006 | to | 7 − 0.017 | Maximum gap | 0.035 |
| | | | | | | | | acceptable | |
| Diameter of the cylinder B (core) | 12 | mm. | Tolerance | From | 12 + 0.018 | to | 12 − 0.000 | Minimum gap | 0.006 |
| | | | | | | | | acceptable | |
| Weight of the core (80%) | 2.100 | gr. | | | | | | | |

| | | | | | |
|---|---|---|---|---|---|
| Stroke of piston B | 14.6 | mm. | Volume | 0.00165 | Cubic decimeters |

| | | | | | |
|---|---|---|---|---|---|
| Density of the candy mass | 1.27 | Kg/dm3 | Weight | 2.100 | grams |

Volume = stroke × diameter × diameter × pi/4
Weight = Volume × density

TABLE 4
Candy Drops

| | RAW MATERIAL | WEIGHT (0) | % | | |
|---|---|---|---|---|---|
| Shell | Cooked Mass | 2000.00 | 99.34% | | |
| | Menthol | 10.05 | 0.50% | | |
| | 2% Color Solution | 2.00 | 0.10% | | |
| | Lemon A | 1.20 | 0.060% | | |
| | TOTAL | 2013.25 | 100.00% | | |
| Center | Cooked Mass | 2000.00 | 98.50% | | |
| | Menthol | 2.00 | 0.10% | | |
| | Lemon B | 28.40 | 1.40% | | |
| | TOTAL | 2030.40 | 100.00% | | |
| | RAW MATERIAL | WEIGHT (g) | % (OUT) | % (IN) | DRY S. (%) |
| Sugar/Corn Syrup - Cooked Mass | Sugar | 3000.00 | 53.14% | 42.86% | 99.90% |
| | Corn Syrup | 3000.00 | 53.31% | 42.86% | 83.00% |
| | Water | 1000.00 | 17.77% | 14.29% | 0.00% |
| | TOTAL Initial | 7000.00 | 124.38% | 100.00% | 78.39% |
| | WATER LOSS | −1372.31 | −24.38% | | |
| | TOTAL final | 5627.69 | 100.00% | | 97.50% |
| | RAW MATERIAL | WEIGHT (g) | % | | DRY S. (%) |
| Color Solution - 2% (concentration) | Water | 98.00 | 98.00% | | 0.00% |
| | Green Color | 2.00 | 2.00% | | 99.00% |
| | TOTAL | 100.00 | 100.00% | | |
| | RAW MATERIAL | % | | | |
| Grouped Recipe - Finished Product | Sugar | 53.31% | | | |
| | HMCS 42 DE/Corn Syrup | 53.31% | | | |
| | Menthol | 0.60% | | | |
| | 2% Color Solution | 0.10% | | | |
| | Flavor Lemon B | 1.40% | | | |
| | Flavor Lemon A | 0.06% | | | |
| | Water | −8.77% | | | |
| | TOTAL | 100.00% | | | |

TABLE 5
Filled Hard Candy

| SHELL CARAMEL RAW | | | | | |
|---|---|---|---|---|---|
| MATERIAL | G | % | | | |
| Cooked Mass | 1982.609 | 99.30% | | | |
| Color Solution | 10.000 | 0.501% | | | |
| Titanium Dioxide | 4.000 | 0.20% | | | |
| TOTAL | 1996.609 | 100.00% | | | |
| FILLING CARAMEL RAW | | | | | |
| MATERIAL | g | % | | | |
| Cooked Mass | 5947.626 | 99.77% | | | |
| Titanium Dioxide | 14.000 | 0.23% | | | |
| TOTAL | 5961.826 | 100.00% | | | |
| SUGAR SOLUTION RAW | | | | 145° C. 0.1 bar | |
| MATERIAL | g | % (OUT) | % (IN) | DRY MATTER | (M.S.) |
| Sugar | 4300.000 | 54.22% | 42.74% | 99.90% | 55% |
| HMCS 38 DE/Corn Syrup | 4300.000 | 54.22% | 42.74% | 82.50% | 45% |
| Deionized Water | 1460.000 | 18.41% | 14.51% | 0.00% | |
| TOTAL | 10060.000 | 128.85% | 100.00% | 77.96% | |
| WATER LOSS | −2129.565 | −28.85% | | | |
| TOTAL | 7930.435 | 100.00% | | 99.90% | |
| Solution | | | | | |
| RAW MATERIAL | g | & (on final) | | DRY S. | |
| Dry Color | 0.400 | 4.00% | | 99.00% | |
| Water | 9.600 | 96.00% | | 0.00% | |
| TOTAL | 10.000 | 100.00% | | 3.96% | |
| GROUPED RECIPE FINISHED | | | | | |
| PRODUCT: | | | | | |
| RAW MATERIAL | 5 | | | | |
| Sugar | 54.031% | SHELL 25.00% | | | |
| | | FILLING 75.00% | | | |
| Glucose HM 4580 | 54.031% HMCS | | | | |
| Brilliant Black solution | 0.125% | | | | |
| Titanium Dioxide 50% | 0.226% | | | | |
| Water | −6.413% | | | | |
| TOTAL | 100.000% | | | | |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An apparatus for producing a confectionery article comprising:
a rotary valve in fluid communication with a source of a fluid confectionery, the rotary valve rotatable to a fluid confectionery dispensing position;
a dispensing outlet in fluid communication with the rotary valve; and
a conveyor for moving a tray under the outlet.

2. The apparatus of claim 1 further comprising a controller in operative communication with the rotary valve and the conveyor, the controller coordinating rotation of the rotary valve and movement of the tray to a confectionery receiving position.

3. The apparatus of claim 2 wherein the rotation occurs at a time period selected from the group consisting of before the movement, during the movement, and after the movement.

4. The apparatus of claim 2 further comprising a piston and cylinder assembly in fluid communication with the rotary valve.

5. The apparatus of claim 4 wherein a piston upstroke transfers an amount of fluid confectionery from the source into the cylinder when the rotary valve is rotated to an intake position.

6. The apparatus of claim 5 wherein the controller is in operative communication with the piston and cylinder assembly, the controller coordinating the piston upstroke to occur at a time period selected from the group consisting of before the movement, during the movement, and after the movement.

7. The apparatus of claim 6 wherein a piston downstroke discharges the amount of fluid confectionery from the dispensing outlet when the rotary valve is in the dispensing position.

8. The apparatus of claim 7 wherein the amount of fluid confectionery is received by the tray.

9. The apparatus of claim 2 wherein a base supports the apparatus, the base movable to a depositing position.

10. The apparatus of claim 9 wherein the controller coordinates base movement to the depositing position with rotation of the rotary valve and movement of the tray to the confectionery receiving position.

11. The apparatus of claim 10 wherein movement of the base to the depositing position occurs at a time period selected from the group consisting of before the tray movement, during the tray movement, and after the tray movement.

12. The apparatus of claim 10 wherein the base movement to the depositing position occurs at a time period selected from the group consisting of before the rotation of the rotary valve to the dispensing position, during the rotation of the rotary valve to the dispensing position, and after the rotation of the rotary valve to the dispensing position.

13. The apparatus of claim 10 wherein the base movement to the depositing position occurs at a time period selected from the group consisting of before the piston upstroke, during the piston upstroke, and after the piston upstroke.

14. The apparatus of claim 1 wherein the source is a passageway for accommodating a flow of fluid confectionery and the rotary valve surrounds the passageway.

15. An apparatus for producing a confectionery article comprising:
a first rotary valve in fluid communication with a source of a first fluid confectionery, the first rotary valve rotatable to a first fluid confectionery dispensing position;
a second rotary valve in fluid communication with a source of a second fluid confectionery, the second rotary valve rotatable to a second fluid confectionery dispensing position;
a dispensing outlet in fluid communication with the first and second rotary valves; and
a conveyor for moving a tray under the outlet.

16. The apparatus of claim 15 further comprising a controller in operative communication with the first and second rotary valves and the conveyor, the controller coordinating rotation of the first and second rotary valves and the movement of the tray to a confectionery receiving position.

17. The apparatus of claim 16 wherein rotation of the first and second rotary valves occurs at a time period selected from the group consisting of before the movement of the tray to the confectionery receiving position, during the movement of the tray to the confectionery receiving position, and after the movement of the tray to the confectionery receiving position.

18. The apparatus of claim 15 wherein the apparatus dispenses a first amount of the first fluid confectionery and a second amount of the second fluid confectionery into the tray when the first and second rotary valves are in the dispensing position.

19. The apparatus of claim 18 wherein the first and second amounts form a laminated confectionery article.

20. The apparatus of claim 16 wherein a base supports the apparatus, the base moveable to a depositing position.

21. The apparatus of claim 20 wherein movement of the base to the depositing position occurs at a time period selected from the group consisting of before movement of the tray to the confectionery receiving position, during movement of the tray to the confectionery receiving position, and after movement of the tray to the confectionery receiving position.

22. The apparatus of claim 20 wherein movement of the base to the depositing position occurs at a time period selected from the group consisting of before rotation of the first and second rotary valves to the respective first and second dispensing positions, during rotation of the first and second rotary valves to the respective first and second dispensing positions, and after rotation of the first and second rotary valve the respective first and second dispensing positions.

23. A method for depositing a fluid confectionery comprising:
providing an apparatus having a rotary valve in fluid communication with a source of a fluid confectionery and a dispensing outlet;
rotating the rotary valve to a fluid confectionery dispensing position;
moving a tray under the dispensing outlet; and
coordinating the rotating with the moving.

24. The method of claim 23 further comprising placing the tray at a confectionery receiving position under the dispensing outlet.

25. The method of claim 24 wherein the rotating occurs at a time period selected from the group consisting of before the placing, during the placing, and after the placing.

26. The method of claim 24 wherein the apparatus further comprises a piston and cylinder assembly in fluid communication with the rotary valve, the method further comprising rotating the rotary valve to a fluid confectionery intake position and transferring an amount of fluid confectionery from the source to the cylinder with a piston upstroke.

27. The method of claim 26 wherein the transferring occurs at a time period selected from the group consisting of before the placing, during the placing, and after the placing.

28. The method of claim 26 further comprising rotating the rotary valve to the dispensing position and dispensing the amount of fluid confectionery from the dispensing outlet with a piston downstroke.

29. The method of claim 28 further comprising receiving the amount of fluid confectionery in the tray.

30. The method of claim 28 further comprising performing a piston upstroke after the dispensing.

31. The method of claim 29 further comprising removing the tray from the receiving position.

32. The method of claim 24 further comprising bringing the apparatus to a depositing position.

33. The method of claim 32 further comprising coordinating the rotating and the moving.

34. The method of claim 33 wherein the bringing occurs at a time period selected from the group consisting of before the placing, during the placing, and after the placing.

35. The method of claim 33 wherein the coordinating further comprises rotating the valve at a time period selected from the group consisting of before the bringing, during the bringing, and after the bringing.

36. A method for depositing a fluid confectionery comprising:
providing an apparatus having a first rotary valve in fluid communication with a source of a first fluid confectionery, a second rotary valve in fluid communication with a source of a second confectionery, and a dispensing outlet;
rotating the first and second rotary valves to respective first and second fluid confectionery dispensing positions;
moving a tray under the dispensing outlet; and
coordinating the rotating with the moving.

37. The method of claim 36 further comprising placing the tray at a fluid confectionery receiving position under the dispensing outlet.

38. The method of claim 37 further comprising dispensing a first amount of the first fluid confectionery and a second amount of the second fluid confectionery from the dispensing outlet into the tray.

39. The method of claim 38 wherein the dispensing of the first and second amounts occurs substantially simultaneously.

40. The method of claim 38 further comprising forming a laminated confectionery article with the first amount and the second amount.

41. The method of claim 39 further comprising encasing the second amount with the first amount.
